(19) United States
(12) Patent Application Publication
(10) Pub. No.: US 2021/0139729 A1
(43) Pub. Date: May 13, 2021

(54) TEXTILE INKJET PRINTING INK

(71) Applicant: International Imaging Materials, Inc., Amherst, NY (US)

(72) Inventors: James West Blease, Avon, NY (US); Daniel Jude Harrison, Pittsford, NY (US)

(73) Assignee: International Imaging Materials, Inc., Amherst, NY (US)

(21) Appl. No.: 16/951,443

(22) Filed: Nov. 18, 2020

Related U.S. Application Data
(63) Continuation of application No. PCT/US2019/039140, filed on Jun. 26, 2019.
(60) Provisional application No. 62/690,652, filed on Jun. 27, 2018.

(51) Int. Cl. C09D 11/38; C09D 11/023; C09D 11/033; C09D 11/101; C09D 11/107; C09D 11/102; D06P 5/30; D06P 5/20; D06P 1/52

(52) U.S. Cl. CPC C09D 11/38; C09D 11/023; C09D 11/033; C09D 11/101; C09D 11/107; D06P 1/5285; D06P 5/30; D06P 5/2077; D06P 5/2005; D06P 1/525; C09D 11/102

(57) ABSTRACT

A system and process for direct printing onto textiles utilizes an aqueous ink having a non-aqueous dispersed liquid phase; a continuous aqueous phase; a thermal initiator; and a colorant. The continuous aqueous phase is comprised of water, a water miscible organic solvent, and a surfactant. The non-aqueous liquid phase, dispersed in the continuous aqueous phase, includes a prepolymer liquid wherein the state of the prepolymer liquid irreversibly changes from a liquid to a solid in response to irradiation of electron beams and/or application of heat.

### PRIORITY INFORMATION

The present application is a continuation application of PCT Patent Application Number PCT/US2019/039140 and claims priority, under 35 U.S.C. § 120, from PCT Patent Application Number PCT/US2019/039140, filed on Jun. 26, 2019. The entire content of PCT Patent Application Number PCT/US2019/039140, filed on Jun. 26, 2019, is hereby incorporated by reference.

PCT Patent Application Number PCT/US2019/039140, filed on Jun. 26, 2019, claims priority, under 35 U.S.C. § 119(e), from U.S. Provisional Patent Application No. 62/690,652, filed on Jun. 27, 2018.

The present application claims priority, under 35 U.S.C. § 119(e), from U.S. Provisional Patent Application No. 62/690,652, filed on Jun. 27, 2018. The entire content of U.S. Provisional Patent Application No. 62/690,652, filed on Jun. 27, 2018, is hereby incorporated by reference.

### BACKGROUND

Textile printing is the process of applying color, patterns, and designs to a fabric. In this process, colorants (dyes or pigments) are applied to the fabric in an image wise fashion. These printed colorants should be strongly bound to the textile, to preserve the quality of the printed image during the life of the textile. In the case of dye based inks, the textile fibers themselves take up and hold the dye. However, dyes are subject to fade by photo and/or chemical oxidation over time, leading to color bleaching. Pigments are very resistant to such fading mechanisms, enabling bleach-resistant textiles to be printed. However, without a vehicle, pigments are not able to bond to the textile and are quickly removed from the fabric by washing or mechanical abrasion. To bond the pigments to the textile, polymeric binders are used.

In the textile printing process, pigmented inks are printed onto the surface of the textile. As the ink is dried on the fabric, these binders serve as an adhesive to bond the pigments to the textile. However, a side effect of pigment bonding is that the binders used in this process may also bind the fibers together, stiffening the fabric and reducing its softness or hand.

Printing textiles with pigmented inks is well known in the art; see for example, U.S. Pat. Nos. 4,154,711; 4,457,980; and 5,853,859. The entire contents of U.S. Pat. Nos. 4,154,711; 4,457,980; and 5,853,859 are hereby incorporated by reference.

Seamless rotary screen printing of textiles was introduced in 1963. This analog printing process still dominates the textile printing production with more than 90% market share. The process is able to print high solids, high viscosity inks onto textiles at fast production speeds. Multiple colored inks can be printed; one atop the other, to build up intricate patterns and designs.

However, such analog printing technologies require different rotary screens for each different pattern. This requires an investment in tooling for each new pattern, changeover time to replace the screens from one pattern to another, and space to inventory all the screens in active use at the printing facility. For custom patterns and/or short textile printing runs, analog printing methods are not the most efficient solution.

Digital printing of textiles offers many advantages over analog printing methods such as screen printing. Changeover time from image to image is essentially eliminated as each digital image file may be quickly loaded into the printer, eliminating the need to change analog printing screens or plates. Color adjustments can be made on the fly, not requiring the ink to be changed out. However, analog printing methods are very productive and printed textiles they produce have very good durability.

Published US Patent Application Number 2003/0160851 discloses that the printing of textiles is currently accomplished primarily by rotary screen methods. In operation, screen printing is rapid and, for large runs, cost effective. The entire content of Published US Patent Application Number 2003/0160851 is hereby incorporated by reference.

However, cutting screens is expensive and time consuming thus making the per-unit cost for short runs quite substantial and, in many cases, prohibitive. A digital printing method such as inkjet printing offers a number of potential benefits over conventional screen printing methods. Digital printing eliminates the set up expense associated with screen preparation and can potentially enable cost-effective short run production. Inkjet printing furthermore allows visual effects such as tonal gradients and infinite pattern repeat size that cannot be practically achieved by a screen printing process.

Inkjet printing is not capable of printing high viscosity inks such as those used in rotary screen printing of textiles. In fact, most inkjet printers require inks with viscosities in the range of 2-10 cps. In contrast, rotary screen inks have viscosities greater than 1000 cps. Consequently, inkjet inks are quite limited in the amount of polymeric binder which can be incorporated to bond the pigment to the fibers, a limitation not shared with screen printing inks. Rotary screen inks contain high loadings of both pigments and polymeric binders.

This allows for a very thin ink layer to be printed onto the surface of the fabric. Because the screen inks are so high in viscosity, the ink bonds to the surface of the textile but does not penetrate down into the textile.

After drying the screened inks on the fabric, the print is durable because the high polymeric resin loading bonds the pigment to the textile and the printed textile remains soft because the printed image is concentrated in a thin surface layer. Additionally, since the ink does not penetrate through the bulk of the fabric, there is little opportunity for the polymeric resin to create adhesive bonds between the fibers which can stiffen the textile.

Fiber and fabric pre-printing treatments, commonly called “pretreatments,” were recognized early on as a means to improve the attachment of inkjet printed pigmented inks to the textile; see for example, U.S. Pat. Nos. 4,702,742 and 6,432,186. Published US Patent Application Number 2006/0210719 and U.S. Pat. No. 8,784,508 describe the use of ink jet to digitally print images onto the pretreated surface of textiles. The entire contents of U.S. Pat. Nos. 4,702,742; 6,432,186; Published US Patent Application Number 2006/0210719; and U.S. Pat. No. 8,784,508 are hereby incorporated by reference.

Published US Patent Application Number 2003/0160851 discloses that another disadvantage of inkjet printing, in particular inkjet printing with pigmented ink, is inkjet printed fabrics are particularly susceptible to color removal by abrasion and thus have poor durability or crock-fastness. This is a consequence of the low polymeric resin load in pigmented inkjet inks. The entire content of Published US Patent Application Number 2003/0160851 is hereby incorporated by reference.

Various means to improve the durability of inkjet printed images on textiles have been disclosed, see for example U.S. Pat. No. 4,597,794, which discloses inkjet inks suitable prepared by dispersing fine particles of pigment into aqueous dispersion medium containing polymer having both a hydrophilic and a hydrophobic construction portion. Wash-fastness was described as excellent as the polymer was able to bond the pigment particles to the textile. U.S. Pat. No. 4,597,794 teaches that the viscosity of a pigmented inkjet ink is controlled in the range of 1 to 20 cP. The entire content of U.S. Pat. No. 4,597,794 is hereby incorporated by reference.

However, no mention of the image sharpness, color intensity, or increase in stiffness of the printed textile was mentioned. Low viscosity inkjet inks will penetrate into a textile after printing. Durability of such printed inks is greatly assisted if the printed ink is not concentrated on the surface but distributed through the bulk of the textile. However, in such a case, the polymeric resin both bonds the pigment to the textile but also bonds the fibers of the textile together, stiffening the printed fabric. Color strength may also be diminished if the ink does not have sufficient pigment loading to overcome the hiding power of the textile fibers surrounding the printed ink.

Published US Patent Application Number 2012/0306976 discloses a means to fix a pigment on the fiber surface without pretreatment, a large amount of emulsion resin for fixing is blended in an ink for printing; while the emulsion resin for fixing can strongly adhere the pigment to fibers, it forms a water-insoluble film upon drying, so that when a large amount is blended, it causes clogging of inkjet nozzles and harden the texture. The entire content of Published US Patent Application Number 2012/0306976 is hereby incorporated by reference.

To overcome many of these issues, fabric pretreatment have been used to concentrate inkjet inks at the surface of the textile to prevent the ink from penetrating into the fabric and to provide sufficient polymeric resin to bond the pigment to the surface of the textile, providing good durability and color strength.

Various fabric pretreatment methods have been described, see for example U.S. Pat. No. 5,958,561 which discloses an ink/textile combination wherein the textile is pretreated with a cross-linkable thermoplastic polymer and then imaged with an aqueous ink and cured at temperatures of 100-190° C. Improved wash-fastness was obtained. The entire content of U.S. Pat. No. 5,958,561 is hereby incorporated by reference.

U.S. Pat. No. 6,146,769 discloses an ink/textile combination wherein an interactive polymer, in the ink or pretreated or on the textile, helps bind the particulate colorant and provide wash-fastness. The entire content of U.S. Pat. No. 6,146,769 is hereby incorporated by reference.

Published US Patent Application Number 2008/0092309 describes the utility of applying a cationic pretreatment to the surface of the textile to enhance the appearance and durability of an inkjet ink printed image. The entire content of Published US Patent Application Number 2008/0092309 is hereby incorporated by reference. The pretreatments for the particular textile substrates include a nonionic latex polymer in order to further enhance the adhesion and/or washfastness of ink colorants on the textile fabric substrates. It has been found that pretreated textiles including a nonionic latex polymer provide high color density and saturation relative to untreated textiles, superior print quality relative to untreated textiles, reduction of wicking or bleeding relative to untreated textiles, and enhanced ink absorption relative to untreated textiles. Furthermore, the pretreatment formulations provide a washfast printed image when printing via an ink jet printing process.

However, fabric pretreatments are not required for rotary screen printing and thus represent an addition expense. While the pretreatment process does provide good durability and image quality for pigmented inkjet inks, it does add a complex step to the process. Additionally, it may add a texture to the surface of the textile which is different from the feel of the unprinted textile and it may increase the stiffness of the textile in the printed areas, altering the hand. Various approaches have been disclosed to eliminate the need for fabric pretreatment of inkjet printed textiles.

Attempts have been made to eliminate the need for fabric pretreatments for pigmented inkjet inks. One such approach is to shift the inkjet ink polymer binder loading closer to that of screen inks. As the loading of solution polymer binders is increased, the ink viscosity quickly increases beyond acceptable levels. However, the polymer binder content of inkjet inks can be increased by substituting polymer dispersions, emulsions, laticies, latexes, and the like for these solution polymers. Polymer dispersions, emulsions, laticies, latexes, etc. are comprised of small polymer particles dispersed into an ink vehicle. Such polymer particles do not increasing the viscosity of the ink vehicle as their loading is increased to the same extent as solution polymers do and thus allow for much higher loadings.

U.S. Pat. No. 6,019,828 discloses the use of aqueous, pigmented, latex containing inkjet inks for textile printing. The entire content of U.S. Pat. No. 6,019,828 is hereby incorporated by reference. Such inks would be expected to provide high durability and wash fastness, although no examples are shown. However, such latex containing ink would necessarily be low in viscosity and thus would be expected to penetrate into the bulk of the textile. Upon drying, the latex particles themselves would be too high in viscosity to wet out and coat the textile fibers. As a consequence, these polymer particles will be expected to reside between and adhere to the fibers of the textile, imparting an undesirable stiffness to the textile.

Published US Patent Application Number 2017/0218565 discloses inkjet printing onto a textile substrate with aqueous inkjet inks containing capsules composed of a polymeric shell surrounding a core which contains one or more thermally curable compounds and pigments and/or disperse dyes which are at least partially encapsulated by polymeric shell material. The capsules disclosed in this patent application are reported to be less than 4 microns, indeed, for most inkjet print heads the maximum size of any particle should theoretically be a factor of 4 to 10 times smaller than the diameter of the inkjet print head nozzle. Published US Patent Application Number 2017/0218565 discloses that the viscosity of the inkjet ink is preferably smaller than 25 mPa·s (cP) at 25° C. and at a shear rate of 90 s⁻¹, more preferably between 2 and 15 mPa·s (cP) at 25° C. and at a shear rate of 90 s⁻¹. The entire content of US Published US Patent Application Number 2017/0218565 is hereby incorporated by reference.

However, those skilled in the art will recognize that for reliable, long term printing performance, inkjet inks rarely contain particles, pigments or capsules with a particle size greater than 1/20^{th} of the diameter of the inkjet print head nozzle or greater than about 0.4 microns. The process also requires the additional step of releasing the contents of microcapsules. It is disclosed that stimulated rupture of the capsules releases the thermally curable compounds.

Published PCT Patent Application WO/2018/049327 discloses a digital UV inkjet printing process which is able to inkjet print directly onto a textile with “at least one print head subassembly carrying at least one inkjet print head that is configured to apply UV-curable ink to the textile according to a digital design file, and at least one UV light source configured to apply UV light to the textile after UV-curable ink is applied to the textile.” While Published PCT Patent Application WO/2018/049327's approach does not require a pretreatment to the fabric, it does apply a thick ink layer which will impart stiffness to the printed textile, reducing its softness (hand). The entire content of Published PCT Patent Application WO/2018/049327 is hereby incorporated by reference.

U.S. Pat. No. 9,845,400 estimates that the thickness of a 100% solids UV curable ink printed onto a textile is in the range of 10-12 microns. U.S. Pat. No. 9,845,400 discloses a waterborne curable ink solution to reduce the ink thickness after drying and UV curing to a few microns. In this ink, a UV cross-linkable polymer is combined with a pigment dispersion, photo-initiators, and amine synergists. The entire content of U.S. Pat. No. 9,845,400 is hereby incorporated by reference.

While these inks showed good abrasion durability after being coated onto a card stock and being UV cured, this patent does not disclose how they would perform if printed onto a textile and cured. Indeed, without a pretreatment it is expected that these inks would penetrate into the textile, making it difficult to fully UV cure. Additionally, the use of water soluble polymers would be expected to generate significant fiber to fiber adhesion upon drying and curing, resulting in significant stiffening of the textile. Similarly, polymeric dispersions would be too high in bulk viscosity to preferentially wet-out and coat fibers.

Consequently, such polymeric dispersions would primarily adhere to the surface of the fibers and aggregate with each other in the inter-fiber voids of the fabric, resulting in significant stiffening of the textile.

U.S. Pat. No. 9,238,742 discloses a water bourn UV curable ink composed of polymer particles encapsulating a pigment and being capable for further polymerization/crosslinking after printing and drying on the textile. The entire content of U.S. Pat. No. 9,238,742 is hereby incorporated by reference.

No fabric pretreatment was reported and thus it is expected that the ink would penetrate into the textile, making it difficult to fully UV cure. Polymer particles are high in bulk viscosity making it difficult for them to wet-out and coat the textile fibers in the printing and drying process. Consequently, such polymer particles would primarily adhere to the surface of the fibers and aggregate with each other in the inter-fiber voids of the fabric, resulting in significant stiffening of the textile.

U.S. Pat. No. 9,238,742 discloses that these printed textile samples have very good abrasion durability, the impact of the inks on the stiffness (hand) of the textile after printing, drying and UV curing is not reported.

Published European Patent Application Number 3156462A1 discloses an aqueous UV curable inkjet ink. This ink is prepared by first mixing a pigment dispersion into a 100% solids mixture of oligomers, dispersants, polymerization inhibitors and photo-initiators. This oil phase pigment dispersion was then emulsified into an aqueous, UV curable, pigmented inkjet ink. These inks were coated onto PET, dried and UV cured to form abrasion resistant coatings. However, these inks were not inkjet printed or coated onto a textile. Published European Patent Application Number 3156462A1 discloses that no fabric pretreatment is usually required for aqueous UV curable inkjet inks and that the viscosity of an aqueous UV free radical curable inkjet ink used is preferably smaller than 100 mPa·s (cP) at 25° C. The entire content of Published European Patent Application Number 3156462A1 is hereby incorporated by reference.

It would be expected that such an ink would penetrate into the textile without a pretreatment, making it difficult to fully UV cure. The impact of the inks on the stiffness (hand) of the textile after printing has not been disclosed in Published European Patent Application Number 3156462A1.

A process has been disclosed (Hakeim, et al., Pig. & Res. Tech., 39 (1), (2010) 3-8 and Prog. Org. Coat., 84 (2015), 70-78 and Coll. & Surf. A, 447 (2014), 172-182 and Pig. & Resin Tech., 47 (2), (2018), 164-172 and Color. Tech., 0, (2017), 1-15) to prepare an aqueous, pigmented, UV curable inkjet ink for textile printing in several scientific publications. In this process acrylic monomers and oligomers were sonicated into a mini-emulsion. A separate pigment dispersion was then co-sonicated with the mini-emulsion to encapsulate the pigments in the oil phase of the mini-emulsion.

When these inks were printed onto un-treated textiles and UV cured, the resulting printed areas had a soft handle and very good fastness properties.

Concerns have been raised (“Think Ink: Fabric Printing with UV-LED Inks” by Ray Work, Sign and Digital Graphics, September 2017) about the safety of wearing clothing printed with UV curable inks. It has been reported that UV inks are very low in viscosity when printed and will penetrate the fabric. To receive curing radiation from the UV-LED lamp the ink should be exposed directly to the UV light. It's likely that some of the ink could be shielded from direct UV light exposure by the overlapping fibers of the fabric. Without full UV light exposure, the reactive chemicals (monomers and oligomers) remain reactive and thus could pose an irritation threat to the person wearing the garment.

Beyond the concerns of unreacted monomers and oligomers which may remain in the textile after UV curing. Concerns have been raised about the safety of photo-initiators and their reaction products for usage in the food packaging industry (Photoinitiators: a food safety review Miguel A. Lagoa, Ana Rodriguez-Bernaldo de Quirósa, Raquel Sendóna, Juana Bustosb, María T. Nietob, and Perfecto Paseiroa. Food Additives & Contaminants: Part A, 2015, DOI: 10.1080/19440049.2015.1014866). Such photo-initiators trigger the polymerization of the monomers and oligomers when the ink is exposed to UV light and are a necessary component of any UV curable ink formulation.

It has been reported that ultraviolet light printing inks are considered safer than the classical inks; however, despite being on the outer surface of the packaging material, their components can migrate into foodstuffs and can give rise to contamination. Photo-initiators are a part of the formulation of printing inks, being an important class of migrant, for which there have been more than 100 incidents of contamination of packaged food with photo-initiators reported through Rapid Alert System for Food and Feed (RASFF) alerts in the European Union. Most of current photo-initiators have a molecular weight under 500 Da (the vast majority around 250 Da or less) and the scission products are smaller; all these molecules, in appropriate circumstances, are likely to migrate into foodstuffs and could be a risk to human health. Printing inks and photo-initiators may be indirect food additives.

Nevertheless, the photo-initiators should comply with the indirect food additive guidelines (21 CFR 170-190) (FDA 2014). The manufacturer is responsible for ensuring that a barrier prevents migration.

While contamination of foodstuffs by monomers, oligomers, photo-initiators and the photo-initiator degradation products should be minimized, contamination of printed textiles which come into skin contact should also be minimized to prevent possible skin irritation, sensitization and other harmful health effects.

European Patent Number 1144755B1 discloses a process to fix inks onto a textile using electron beams. These are produced by acceleration and focusing of electrons which are emitted by thermionic, field or photoemission and by electron or ion bombardment from a cathode. Radiation sources are electron guns and accelerators of customary design. The entire content of European Patent Number 1144755B1 is hereby incorporated by reference.

Examples of radiation sources are known from the literature, e.g. International Journal of Electron Beam & Gamma Radiation Processing, in particular 1/89 pages 11-15; Optik, 77 (1987), pages 99-104. The advantage of electron beam curing is that photo-initiators are not required. Additionally, the electron bean is able to penetrate through the entire printed textile, ensuring the effective polymerization and/or crosslinking throughout the printed ink, greatly reducing and/or eliminating residual monomers, oligomers and crosslinking agents.

Digital textile printing has tremendous potential to transform the apparel industry. However, process steps such as pretreatment should be first eliminated to reduce cost and process complexity. Ink technologies which do not require pretreatment should not stiffen the fabric, reduce the hand, or create unacceptable surface texture or feel. Printed textile inks should also be free of harmful chemicals which could pose health issue related to skin contact.

Elimination of fabric pretreatments for pigmented inkjet inks will greatly improve the economic viability of this digital printing technology over analog printing methods such as rotary screen.

To overcome the limitations of pigmented inkjet inks to maintain a low viscosity for printability while achieving a high binder loading to achieve good durability, it is been discovered that liquid prepolymer oils may be used in such inkjet inks

Oils which are dispersed into an aqueous vehicle are commonly referred to as emulsions whereas solids dispersed into an aqueous vehicle are commonly referred to as dispersion. Like polymer dispersions, emulsions, laticies, and latexes, the separation of binder and liquid ink vehicle into different phases allows the viscosity to remain low while the loading of binder can be high. However, unlike polymer dispersions, emulsions, laticies and latexes, the prepolymer oil droplets in the emulsions have the advantage of having a low bulk viscosity. This enables such oil droplets wet out and coat the surface of the fiber after printing and drying.

Polymerization of the prepolymer oils directly on the fiber surface minimizes the fiber to fiber bonding which stiffens the fabric, reducing hand. When the polymer binder concentration of an inkjet ink is increased using high viscosity polymer particles, such particles are high in bulk viscosity and can't easily wet out and coat the fibers after printing and drying. Consequently, these particles will condense in the inter-fiber spaces and on fibers themselves. Drying will cause these polymer particles to aggregate with each other and to adhere to both the pigment particles and the fibers, creating multiple additional connection points between the fibers and consequently increasing the stiffness of the printed textile.

Prepolymer liquids are comprised of polymerizable compounds and may optionally include monomers, oligomers, initiators, solvents, plasticizers, adhesion promotors, stabilizers, light absorbers, dyes, pigments, antioxidants, catalysts and the like. In a preferred embodiment, pre-polymer liquids have viscosities in the range ˜1 cP to 1×10⁷ cP.

The viscosity of a liquid is a measure of its resistance to flow—the opposite of fluidity. Viscosities are expressed in units of centi-poises (cP). At room temperature, the viscosity of water is about 1 cP. Molasses has a viscosity of about 50,000 cP and is able to flow and wet-out surfaces. In fact, given a bit of time, Brie cheese, with a viscosity of 5×10⁷ cP can flow out of its rind into a rounded mass.

However, once liquids are transformed into solids, such as by cooling molten glass to a temperature below its glass transition temperature or by polymerizing a monomer liquid into a solid, the viscosity becomes very high and difficult to measure. For example, the viscosity of SiO₂, just below its glass transition temperature at 1100° C. has a viscosity of 4.0×10¹⁴ cP to 2.5×10¹⁶ cP (CRC Materials Science and Engineering Handbook, J. F. Shackelford, Editor, CRC Press, Boca Raton, 1994, p. 348.), such high viscosity solids are not able to flow at ambient temperatures and pressures.

The change in viscosity of monomers and oligomers during the polymerization process increases linearly with increasing molecular weight until the polymer chain length grows to a certain length. Above this molecular weight, the polymer chain length is long enough for entanglement with other chains. According to Fetters (“Chain dimensions and entanglement spacing”, by L. J. Fetters, et. al., Chap. 25, Physical Properties of Polymers Handbook 2nd ed. 2007 Edition by James E. Mark (Editor), Springer Press.), the molecular weight for entanglement denotes the transition in melt viscosity/molar mass relation as the exponents change from ˜1 to ˜3.4. It is below this entanglement molecular weight that monomers, oligomers and polymers have viscosities low enough for good flow and wetting. At ambient temperatures, Fetters reports that the entanglement molecular weight for polyethylacrylate is 7,700 and for polymethylacrylate 11,000.

Above the entanglement molecular weight the viscosity of a polymer quickly rises above 1×10⁷ cP (“Melt Viscosity-Molecular Weight Relationship for Linear Polymers” by R. H. Colby, et. al., Macromolecules, 1987, 20, p. 2226-2237.) into the range where viscosity is very difficult to measure because solid materials are very resistant or unable to flow.

Once the polymerization of a prepolymer oil begins, the viscosity of the reactants will begin to rise immediately and once the polymer chains begin to become entangled the viscosity will quickly reach level associated with solids materials which have poor flow and wetting capabilities under ambient conditions. Indeed, polymers having molecular weights above the entanglement molecular weight have the tough, durable properties which make them useful as durable binders, coatings and films.

In summary, the conventional processes for printing with inks onto textiles resulted in problems associated with the textile being too stiff, the ink not being fully cured by the UV curing process, loss of printed ink due to abrasion, fading, color leeching during laundering, and color development.

To overcome the above problems, it is desirable to use an ink for the inkjet printing of textiles that is water based, pigmented, heat and/or electron beam curable.

In addition, it is desirable to use an ink for the inkjet printing of textiles that is water based, pigmented, heat and/or electron beam curable and that is capable of being printing directly onto textiles.

### BRIEF DESCRIPTION OF THE DRAWINGS

The drawings are only for purposes of illustrating various embodiments and are not to be construed as limiting, wherein:

FIG. 1 shows a schematic diagram of a textile printing process;

FIG. 2 shows a schematic diagram of an aqueous inkjet ink;

FIG. 3 shows a schematic diagram of another aqueous inkjet ink;

FIG. 4 shows a schematic diagram of an unprinted woven textile fabric;

FIG. 5 shows a schematic diagram of a woven textile fabric printed with the aqueous inkjet ink of FIG. 2;

FIG. 6 shows a schematic diagram of a woven textile fabric printed with the aqueous inkjet ink of FIG. 3;

FIG. 7 shows a schematic diagram of an aqueous inkjet ink;

FIG. 8 shows a schematic diagram of another aqueous inkjet ink;

FIG. 9 shows a schematic diagram of a third aqueous inkjet ink;

FIG. 10 shows a schematic diagram of a fourth aqueous inkjet ink;

FIG. 11 shows a schematic diagram of a fifth aqueous inkjet ink;

FIG. 12 shows a schematic diagram of a sixth aqueous inkjet ink;

FIG. 13 shows a schematic diagram of a seventh aqueous inkjet ink;

FIGS. 14 and 15 show schematic diagrams of an aqueous inkjet ink set; and

FIG. 16 is a block diagram illustrating a process of applying aqueous inkjet ink to a textile and curing thereof.

### DETAILED DESCRIPTION

For a general understanding, reference is made to the drawings. In the drawings, like references have been used throughout to designate identical or equivalent elements. It is also noted that the drawings may not have been drawn to scale and that certain regions may have been purposely drawn disproportionately so that the features and concepts may be properly illustrated. Moreover, in the various embodiments described below, the particulars are given by way of example and for the purposes of illustrative discussion of embodiments.

Unless otherwise defined, all technical and scientific terms used herein have the same meaning as is commonly understood by one of skill in the art.

FIG. 1 shows a schematic diagram of a preferred embodiment comprising a textile printing process 5. As illustrated in FIG. 1, at step 10, a low viscosity ink, in an image-wise fashion, is printed onto the surface of a textile fabric. The low viscosity ink 50, as illustrated in FIG. 2, is comprised of a prepolymer oil emulsion 51 and a pigment dispersion 53.

As illustrated in FIG. 1, at step 12, the printed ink penetrates the textile fabric. At step 14, the volatile components of the low viscosity ink are dried, preferably at a temperature of 60 to 120° C., and the non-volatile prepolymer oil and pigment particles are concentrated.

At step 16, the prepolymer oil and pigment particles condense and wet-out the textile fibers, to form a coating of prepolymer oil and pigment particles on the surface of the textile fibers. At step 18, the prepolymer oil is polymerized, either with the application of heat, through either exposing the printed textile fibers to elevated temperatures above an initiation temperature of about 120° C. for such polymerization or irradiating the printed textile fibers with electron beams with a dose preferably between 1 and 40 kGy. The application of heat, through exposure to elevated temperatures and/or irradiation by electron beams, changes the state of the prepolymer oil coating on the textile fibers from a liquid to a solid polymeric coating, which encapsulates and adheres the pigment particles onto the surface of the fibers.

FIG. 2 shows a schematic diagram of an aqueous inkjet ink 50. As illustrated in FIG. 2, aqueous inkjet ink 50 comprises liquid prepolymer oil droplets 51, emulsified into a low viscosity aqueous ink vehicle 52. Aqueous inkjet ink 50 also comprises pigment particles 53 dispersed in the aqueous ink vehicle 52.

FIG. 3 shows a schematic diagram of an aqueous inkjet ink 60. As illustrated in FIG. 3, aqueous inkjet ink 60 depicts a high viscosity particle 61 dispersed into a low viscosity aqueous ink vehicle 52. Aqueous inkjet ink 60 also comprises a pigment particle 53 dispersed in the aqueous ink vehicle 52.

FIG. 4 illustrates a schematic diagram of an unprinted woven textile fabric. As illustrated in FIG. 4, an unprinted woven textile fabric includes fibers 110, fiber surface 109, and inter-fiber spaces 111.

FIG. 5 illustrates a schematic diagram of a woven textile fabric printed with the aqueous inkjet ink 50 of FIG. 2 and dried. As illustrated in FIG. 5, the liquid prepolymer oil droplets 51 of aqueous inkjet ink 50 have wet-out the surface 109 of the textile fiber 110 to form a prepolymer oil coating 112 on the textile fiber 110. Such liquid prepolymer oil droplets 51 are low in bulk viscosity and low in surface energy.

As described in step 12 of FIG. 1, after aqueous inkjet ink 50 has been printed onto the textile fabric, the aqueous inkjet ink 50 penetrates into the bulk of the textile, bringing the liquid prepolymer oil droplets 51 into close contact with the surface 109 of the textile fibers 110. As the ink vehicle 52 evaporates in the drying process, at step 14 of FIG. 1, the fibers 110 present a surface 109 onto which the oil droplets 51 can condense. Since the viscosity of the oil droplets 51 are low, the liquid prepolymer oil droplets 51 will preferentially wet the textile fibers 110 to form a prepolymer coating 112, at step 16 of FIG. 1.

Also, as the ink vehicle 52 evaporates in the drying process, pigment particles 53 of ink 50 present a surface onto which the oil droplets 51 can coalesce. As the ink 50 dries and concentrates the non-volatile components, the pigment particles 53 will become attached to and encapsulated by the prepolymer oil coating 112 on the textile fibers 110.

With application of sufficient heat and/or irritation with electron beams to induce polymerization, step 18 of process 5, the state of the prepolymer oil coating 112 is transformed from a liquid into a high viscosity solid polymer coating which firmly attaches itself to the textile fibers 110 and to the pigment particles 53, forming a durable printed textile 102.

After printing, drying, and prepolymer polymerization, the printed textile 102 will maintain an open inter-fiber space 111 with minimal interlocking of fibers 110. The printed textile 102 will have a comparable feel and stiffness to unprinted textile 101.

FIG. 6 illustrates a woven textile fabric printed with the aqueous inkjet ink 60 of FIG. 3 and dried. As illustrated in FIG. 6, the particles 61 of ink 60 are comprised of polymers which have settled onto the surface 109 of fibers 110 and into the inter-fiber spaces 111. Such polymer particles 61 are solids which are high in bulk viscosity.

After inkjet printing onto the textile fabric, the ink 60 will penetrate into the bulk of the textile, bringing the polymer particles 61 and the pigment particles 53 into close contact with the surface 109 of textile fibers 110. As the ink vehicle 52 evaporates in the drying process, the fibers 110 present a surface 109 onto which the polymer particles 61 can settle. During the drying process, the pigment particles 53 will also come into direct contact with the polymer particles 61 and textile fibers 110.

Since the viscosity of the solid polymer particles 61 are high, the solid polymer particles 61 will be unable to coat the surface 109 of the textile fibers 110 to the same extent as the, liquid prepolymer oil droplets 51. This is a consequence of the high viscosity of solid polymer particles 61 which creates a rheological barrier to wetting out onto the fiber surface 109.

With application of sufficient heat to induce softening, the polymer particles 61 will adhesively bond to themselves, to the pigment particles, as well as, to the surface 109 of the textile fibers 110. In variably, some of the polymer particles will form aggregates 114 between fibers 110 and in the inter-fiber spaces 111, creating additional adhesion between textile fibers 110, increasing the stiffness of the fabric.

FIG. 7 shows a schematic diagram of an aqueous inkjet ink. As illustrated in FIG. 7, the aqueous inkjet ink comprises liquid prepolymer oil droplets 51 comprising oligomers and optionally monomer(s), water insoluble thermal initiator(s), and monomeric dispersant(s), all emulsified into a low viscosity aqueous ink vehicle 52. Pigment particles 210 are encapsulated within the prepolymer oil droplets 51. Prepolymer oil droplets 51 optionally have a stabilizing surface layer 211.

FIG. 8 shows a schematic diagram of an aqueous inkjet ink. As illustrated in FIG. 8, the aqueous inkjet ink comprises liquid prepolymer oil droplets 51 comprising oligomers and optionally of monomer(s), water insoluble thermal initiator(s), and monomeric dispersant(s), all emulsified into a low viscosity aqueous ink vehicle 52. Pigment particles 210 are encapsulated within the prepolymer oil droplets 51. Prepolymer oil droplets 51 optionally have a stabilizing surface layer 211. Initiator particles 212 may be incorporated into ink 201 by means of dissolving a thermal initiator in a hydrophobic solvent and emulsifying the resulting oil into ink vehicle 52 or by encapsulating the thermal initiator and dispersing the resulting capsules 212 into ink vehicle 52.

FIG. 9 shows a schematic diagram of an aqueous inkjet ink. As illustrated in FIG. 9, the aqueous inkjet ink comprises liquid prepolymer oil droplets 214 essentially consisting comprising oligomers and optionally of monomer(s), water insoluble thermal initiator(s), and monomeric dispersant(s), all emulsified into a low viscosity aqueous ink vehicle 52. Pigment particles 213 are dispersed in ink vehicle 52.

FIG. 10 shows a schematic diagram of an aqueous inkjet ink. As illustrated in FIG. 10, the aqueous inkjet ink comprises liquid prepolymer oil droplets 54 comprising oligomers and optionally of monomer(s), water insoluble thermal initiator(s), and monomeric dispersant(s), all emulsified into a low viscosity aqueous ink vehicle 52. Pigment particles 210 are encapsulated within the prepolymer oil droplets 54. Prepolymer oil droplets 54 optionally have a stabilizing surface layer 211. Initiator particles 215 may be incorporated into ink 204 by means of dispersing the water insoluble initiator into the ink vehicle 52.

FIG. 11 shows a schematic diagram of an aqueous inkjet ink. As illustrated in FIG. 11, the aqueous inkjet ink comprises latex emulsion of polymerizable polymer/oligomer particles 216 dispersed into a low viscosity aqueous ink vehicle 52. Pigment particles 213 are dispersed in ink vehicle 52. Water soluble or water dispersible thermal crosslinkers 217 are incorporated into ink vehicle 52.

FIG. 12 shows a schematic diagram of an aqueous inkjet ink. As illustrated in FIG. 12, the aqueous inkjet ink comprises low molecular weight crosslinkable polymer droplets 218 emulsified into a low viscosity aqueous ink vehicle 52. Pigment particles 213 are encapsulated within the polymer droplets 218. Water soluble or water dispersible thermal crosslinkers 217 are incorporated into ink vehicle 52.

FIG. 13 shows a schematic diagram of an aqueous inkjet ink. As illustrated in FIG. 13, the aqueous inkjet ink comprises low molecular weight, liquid crosslinkable polymer droplets 219 emulsified into a low viscosity aqueous ink vehicle 52. Pigment particles 213 are dispersed in ink vehicle 52. Water soluble or water dispersible thermal crosslinkers 217 are incorporated into ink vehicle 52.

FIG. 14 shows a schematic diagram of an aqueous inkjet ink. As illustrated in FIG. 14, the aqueous inkjet ink comprises of liquid prepolymer oil droplets 51 comprising oligomers and optionally of monomer(s), water insoluble thermal initiator(s), and monomeric dispersant(s), all emulsified into a low viscosity aqueous ink vehicle 52. Pigment particles 210 are encapsulated within the prepolymer oil droplets 51. Prepolymer oil droplets 51 optionally have a stabilizing surface layer 211.

FIG. 15 shows a schematic diagram of a companion liquid to the aqueous inkjet ink of FIG. 14. As illustrated in FIG. 15, the companion liquid comprises water soluble or water dispersible thermal crosslinkers 217 incorporated into ink vehicle 52.

Separation of the aqueous inkjet ink of FIG. 14 and the companion liquid of FIG. 15 into separate ink channels within an ink jet printer creates a separation between the prepolymer components and the polymerization initiator, thereby increasing the shelf life of the ink.

FIG. 16 is a block diagram illustrating a process of applying aqueous inkjet ink to a textile and curing thereof. As illustrated in FIG. 16, an inkjet printing device 300 applies ink 310 to a textile 500 to create an inked textile 550. A drying and curing device 400 generates heat and optionally electron beams (410). The heat 410 enables the removal of volatile ink components from the inked textile 550 and causes the prepolymer oil and pigments to condense and coat the fibers of the inked textile 550,

The application of heat by the drying and curing device 400 above specified temperature and time enables the polymerization of the prepolymer oils to lock the pigment onto the inked textile 550 to create a printed textile 575.

Alternatively, the irradiation of the inked textile 550 by the electron beams 410 enables the polymerizing the prepolymer to lock the pigment onto the inked textile 550 to create a printed textile 575.

The application of heat by the drying and curing device 400 above specified temperature and time enables the polymerization of the prepolymer oils to lock the pigment onto the inked textile 550 to create a printed textile 575.

Alternatively, the application of heat and electron beams by the drying and curing device 400 above specified temperature, time and electron beam dosage enables the polymerization of the prepolymer oils to lock the pigment onto the inked textile 550 to create a printed textile 575.]

The various aqueous inkjet inks disclosed herein are comprised of non-aqueous dispersed phases (emulsions and dispersions) and a continuous aqueous phase. The term emulsion generally refers to a dispersed liquid phase suspended as small droplets in a continuous liquid phase. When the continuous phase primarily comprises water and the suspended droplet phase is hydrophobic/immiscible with water, the term oil-in-water emulsion is often used to describe the emulsion. The term dispersion generally refers to a solid suspended as small particles in a continuous liquid phase.

Any methods known to those skilled in the art may be used to prepare the aforementioned emulsions and dispersions. To prepare stable oil-in-water emulsions, typically homogenization methods that employ high energy input via mechanical shear forces or high frequency sound waves are used to break down larger droplets of the suspended phase liquid into suitably small droplets suspended in the continuous phase liquid. Examples of homogenization methods for preparation of stable oil-in-water emulsions high mechanical shear forces include high shear mixers such as those manufactured by Silverson® and high pressure homogenizers, such as Microfluidics™ Microfluidizer® and similar devices. Homogenation processes that expose the emulsion to high frequency (ultrasonic) sound waves, also known as sonication include devices manufactured by Branson, Qsonica and the like.

To prepare stable dispersions with solid dispersed phases such as pigments, typically methods employed devices such as ball mills, media mills, attritors, three roller mills, planetary mills and the like.

For both emulsion and dispersion preparation it is well known in the art that surface active compounds, also known as surfactants, dispersants, emulsifiers, surfmers, dispersing aids, grinding aids, and the like, are employed to enable rapid and efficient oil droplet or particle reduction in the continuous phase.

Any surface active compounds may be used without limitation. The surface active compounds employed for the purpose of preparing stable emulsion and dispersions may be categorized broadly by molecular weight as small molecule such as sodium dodecyl sulfate, oligomeric or polymeric and further categorized by their electrical charge structure into anionic, cationic, zwitterionic and non-ionic categories.

The inkjet ink non-aqueous dispersed phase comprises one or more oligomeric compounds and optionally one or more of the following: monomers, polymerizable pre-polymers, polymers, crosslinkers, water immiscible or sparingly miscible organic solvents, surfactants including surfactants capable of undergoing polymerization, also known as “surfmers”, thermal polymerization initiators, organic or inorganic pigments, oil soluble dyes, polymerization catalysts and/or inhibitors and/or stabilizers, UV light absorbers, antioxidants, adhesion promotors and plasticizers.

In another embodiment, the inkjet ink comprises a second non-aqueous dispersed phase comprising one or more organic or inorganic pigments and optionally one or more of the following: surfactants including surfmers and or dispersants and stabilizers. The pigment may be stabilized by surfactants, polymeric dispersants, encapsulated via crosslinked dispersants or self-dispersed by means of hydrophilic groups covalently bonded to the pigment surface.

In another embodiment, the inkjet ink comprises an aqueous continuous phase comprising water and optionally one or more of the following: water soluble polymerizable monomers, oligomers, pre-polymers and polymers, water miscible and or water soluble organic solvents, thermal polymerization initiators, surfactants and or dispersants including surfmers, polymeric resins in solution form and or in dispersed (latex emulsion) form, crosslinking agents, polymerization catalysts and/or inhibitors, pH adjusting agents, agents for suppressing growth of biological organisms (bacteriacides/fungicides), anti kogation agents, anti-foaming agents and the like.

To prepare the inkjet ink, the emulsion comprising the liquid prepolymer oil dispersed in an aqueous vehicle and the solid dispersion comprising the pigment colorant dispersed in an aqueous vehicle may be prepared separately by any of the previously described means.

Water soluble or readily dispersible components of the aqueous continuous phase may be pre-dissolved prior to preparation of the emulsion or dispersion. Subsequent to the individual preparation of the emulsion and/or dispersion they may be combined by simple admixing or combined in a manner that employs homogenization methods previously described to prepare the final ink composition.

Among the functional requirements for formulation of a practical inkjet ink is the particle size distribution of dispersed phased in the ink composition.

Specifically citing Derby and Reis (MRS Bulletin, November, 2003, pg. 815-818): “Great care must be taken to ensure that no dilatancy (viscosity increasing rapidly with shear rate) occurs at high strain rates. Within an inkjet printer, dilatancy might occur within the constrained dimension of the printer orifice if the particles interact with the walls and form an obstacle blocking the flow. In order to minimize this likelihood, the maximum size of the particles must be significantly smaller than the diameter of the orifice. From analogies with dry powder flow, the diameter of the largest particles present should be no greater than 1/20 of the orifice diameter.”

Dispersed phase oil droplets comprising polymerizable compound(s) and pigment particles in the inkjet ink should be sufficiently small to permit free flow of the ink through the inkjet-printing device, especially at the ejecting nozzles. It is also desirable to use small particles for maximum color strength and to slow down sedimentation.

When measured by a laser diffraction particle sizing apparatus such as the Horiba LA-950 and the like, the volume average pigment particle size of a dispersed non-white pigment is preferably between 0.020 and 1 μm, more preferably between 0.040 and 0.200 μm and particularly preferably between 0.050 and 0.150 μm.

Most preferably, the numeric average pigment particle size is no larger than 0.100 μm. For the white pigment dispersion when measured by a laser diffraction particle sizing apparatus such as the Horiba LA-950 and the like, the volume average pigment particle size of the white pigment is preferably from 50 to 500 nm, more preferably from 150 to 400 nm, and most preferably from 200 to 350 nm.

Sufficient hiding power cannot be obtained when the average diameter is less than 50 nm, and the storage ability and the jet-out suitability of the ink tend to be degraded when the average diameter exceeds 500 nm.

The pigment amount in the inkjet inks is preferably at a concentration of 0.5 to 20 wt %, more preferably 1.0 to 15 wt % and most preferably 2.0 to 10 wt. % based on the total weight of the inkjet ink. The polymerizable oil amount in the inkjet inks is preferably at a concentration of 0.5 to 20 wt %, more preferably 1.0 to 15 wt % and most preferably 2.0 to 10 wt. % based on the total weight of the inkjet ink.

It is known by those skilled in the art that in order to consistently eject ink from an ink jet print head the physical properties of the inkjet ink are constrained by certain physical parameters namely the liquid density, liquid viscosity, liquid surface tension and a characteristic dimension of the print head device namely the diameter of the print head nozzle orifice. The combination of parameter values is described by the dimensionless inverse Ohnesorge number (Oh⁻¹) also known as the Z number and is defined as:

$$Z = \frac{{( a ργ )}^{1 \text{/} 2}}{μ}$$

Where a represents the nozzle diameter (the characteristic dimension), p represents the inkjet ink density, X represents the ink surface tension and μ represents the ink viscosity. The latter three parameters are determined at a fixed temperature. According to Derby and Reis (MRS Bulletin, 2003, 28, 815-818), a consistently printable inkjet ink should have a combination of the above physical properties to provide a Z value between 1 to 10.

The inkjet inks preferably have Z values between 1 to 10, more preferably between 3 to 7. When measured at 25° C., the density of the inkjet inks is preferably between 1.00 to 2.00 grams/cm3 more preferably 1.02 to 1.20 grams/cm3. The surface tension of the inkjet ink can be measured at a fixed temperature by any commonly used devices for this purpose employing methods such as a DuNouy ring tensiometer, Wilhemy plate tensiometer or bubble pressure tensiometer and the like.

When measured at 25° C., the surface tension of the inkjet inks are preferably between 15 to 60 milliNewtons/meter (mN/m), more preferably between 20 to 60 mN/m and most preferably between 25 to 50 mN/m. The viscosity of the ink jet ink can be measured at a fixed temperature by any commonly used device for this purpose employing methods such as rotating spindle viscometer for example those manufactured by Brookfield, rotating cone and plate viscometer, rolling ball viscometer, capillary viscometer and the like. When measured at 25° C., inkjet inks are preferably between 1 to 10 centipoise (cP), more preferably between 2 and 8 cP and most preferably between 2.5 and 7.5 cP.

It is well known in the art that inkjet inks much exhibit stable physical and chemical properties over time in order to be used successfully. One method of assessing the stability of inkjet inks is to store the inks at room temperature over an extended period of time, for example six months to two years or more while periodically sampling the inkjet inks for changes to properties such as pH, viscosity, surface tension, particle size distribution, and the like. However, extended storage at room temperature is inefficient and detrimental to rapid development of inkjet ink formulation.

For that reason, accelerated aging techniques are employed, primarily storing the inkjet inks at elevated temperatures ranging from for example 30° C. to 80° C. and assessing change to the inkjet ink properties over shorter periods of time for example on a weekly time interval. One commonly used temperature and time combination used by those skilled in the art is two weeks of storage at 60° C. Other commonly used combinations are four weeks at 60° C., six weeks at 60° C., and so forth.

For inkjet inks, it is preferred that after storage for two weeks at 60° C., the observed pH change does not exceed one pH unit, the ink viscosity change does not exceed 1 cP, the median particle size change does not exceed 10% and the 95^{th} percentile particle size change does not exceed 20%.

Published US Patent Application Number 2017/0022379 discloses several free radical polymerizable compounds useful in inkjet printing. The entire content of Published US Patent Application Number 2017/0022379 is hereby incorporated by reference.

Water insoluble, polymerizable compounds commonly known in the art may be used as components of the liquid prepolymer oil. Monomers, oligomers and/or polymers may be used in combination The monomers, oligomers and/or polymers may possess different degrees of functionality, and a mixture including combinations of mono-, di-, tri- and higher functionality monomers, oligomers and/or polymers may be used. Useful monofunctional polymerizable monomer(s) and/or oligomer(s) may be found in the Polymer Handbook Vol 1+2, 4th edition, edited by J. BRANDRUP et al., Wiley-Interscience, 1999.

The liquid prepolymer oil may also contain polymerizable oligomers preferably with molecular weights below the entanglement molecular weight. Examples of polymerizable oligomers include epoxy acrylates, aliphatic urethane acrylates, aromatic urethane acrylates, polyester acrylates, and straight-chained acrylic oligomers. Such oligomers may be incorporated in the liquid prepolymer oil, so long as the bulk viscosity of the said oil does not exceed 1×10⁷ cP under the temperature conditions of the textile drying process, Step 14 of process 5 in FIG. 1.

Preferred monofunctional and/or polyfunctional acrylate monomers and oligomers are isoamyl acrylate, Stearyl acrylate, lauryl acrylate, octyl acrylate, decyl acrylate, isoamylstyl acrylate, isostearyl acrylate, 2-ethylhexyl-diglycol acrylate, 2-hy droxybutyl acrylate, 2-acryloyloxyethylhexahydrophthalic acid, butoxyethyl acrylate, ethoxydiethylene glycol acrylate, methoxydiethylene glycol acrylate, methoxypolyethylene glycol acrylate, methoxypropylene glycol acrylate, phenoxyethyl acrylate, tetrahydrofurfuryl acrylate, isobornyl acrylate, 2-hydroxyethyl acrylate, 2-hydroxypropyl acrylate, 2-hydroxy-3-phenoxypropyl acrylate, vinyl ether acrylate, 2-acryloyloxyethylsuccinic acid, 2-acryloyxyethylphthalic acid, 2-acryloxyethyl-2-hydroxyethyl-phthalic acid, lactone modified flexible acrylate, and t-butylcyclohexyl acrylate, triethylene glycol diacrylate, tetraethylene glycol diacrylate, polyethylene glycol diacrylate, dipropylene glycol diacrylate, tripropylene glycol diacrylate, polypropylene glycol diacrylate, 1,4-butanediol diacrylate, 1.6-hexanediol diacrylate, 1.9-nonanediol diacrylate, neopentylglycol diacrylate, dimethylol-tricyclodecane diacrylate, bisphenol A EO (ethylene oxide) adduct diacrylate, bisphenol A PO (propylene oxide) adduct diacrylate, hydroxypivalate neopentyl glycol diacrylate, propoxylated neopentyl glycol diacrylate, alkoxylated dimethyloltricyclodecane diacrylate and poly tetramethylene glycol diacrylate, trimethylolpropane triacrylate, EO modified trimethylolpropane triacrylate, tri (propylene glycol) triacrylate, caprolactone modified trimethylolpropane triacrylate, pentaerythritol triacrylate, pentaerithritol tetraacrylate, pentaerythritolethoxy tetraacrylate, dipentaerythritol hexaacrylate, ditrimethylolpropane tetraacrylate, glycerinpropoxy triacrylate, and caprolactam modified dipentaerythritol hexaacrylate, or an N-vinylamide such as, N-Vinylcaprolactam or N-vinylformamide; or acrylamide or a substituted acrylamide, such as acryloylmorpholine.

Suitable monofunctional acrylates include caprolactone acrylate, cyclic trimethylolpropane formal acrylate, ethoxylated nonyl phenol acrylate, isodecyl acrylate, isooctyl acrylate, octyldecyl acrylate, alkoxylated phenol acrylate, tridecyl acrylate, and alkoxylated cyclo hexanone dimethanol diacrylate.

Suitable examples of vinylnaphthalene compounds are 1-vinylnaphthalene, a-methyl-1-vinylnaphthalene, b-methyl-1-vinylnaphthalene, 4-methyl-1-vinylnaphthalene and 4-methoxy-1-vinylnaphthalene.

Suitable examples of N-vinyl heterocyclic compounds are N-vinylcarbazole, N-vinylpyrrolidone, N-vi nylindole, N-vinylpyrrole, N-vinylphenothiazine, N-vinylacetoanilide, N-vinylethylacetoamide, N-vinylsuccinimide, N-vinylphthalimide, N-vinylcaprolactam, and N-vinylimidazole.

Suitable examples of styrene compounds are styrene, p-methylstyrene, p-methoxystyrene, b-methylstyrene, p-methyl-b-methylstyrene, a-methylstyrene, and p-methoxy b-methylstyrene.

A variety of inkjet organic co-solvents are disclosed in Published US Patent Application Number 2017/0218565 and U.S. Pat. No. 8,287,112. The entire contents of Published US Patent Application Number 2017/0218565 and U.S. Pat. No. 8,287,112 are hereby incorporated by reference.

Water immiscible solvents may be incorporated into the liquid prepolymer oil. A water immiscible solvent is an organic solvent having low miscibility in water. Low miscibility is defined as any water solvent combination forming a two phase system at 20° C. when mixed in a one to one ratio. Preferably, the solvents are non-polar or have relatively low polarity.

Specific examples of water-immiscible solvents that may be utilized include water-immiscible esters, such as ethyl acetate, isopropyl acetate, n-propyl acetate, isobutyl acetate, n-butyl acetate, isobutyl isobutyrate, 2-ethylhexyl acetate, ethylene glycol diacetate, “Exxate 900” solvent (a C9 acetate commercially available from Exxon Corp., Houston, Tex.) and “Exxate 1000” solvent (a C10 acetate commercially available from Exxon Corp., Houston, Tex.); water-immiscible ketones such as methyl ethyl ketone, methyl isobutyl ketone, methyl isoamyl ketone, methyl n-amyl ketone, diisobutyl ketone, cyclohexanone and isophorone; water-immiscible aldehydes such as acetaldehyde, n-butyraldehyde, crotonaldehyde, 2-ethylhexaldehyde, isobutylaldehyde and propionaldehyde: water-immiscible ether esters such as ethyl 3-ethoxypropionate: water-immiscible aromatic hydrocarbons such as toluene, xylene and “AMSCO-SOLV G” solvent (an aromatic hydrocarbon solvent commercially available from Unocal Corp., Schaumberg, Ill.); water-immiscible halohydrocarbons such as 1,1,1 trichloroethane; water-immiscible glycol ether esters such as propylene glycol monomethyl ether acetate (commercially available as “Ektasolv® PM Acetate” from Eastman Chemical Products, Inc., Kingsport, Tenn.), ethylene glycol monoethyl ether acetate (commercially available as “EE Acetate” from Eastman Chemical Products, Inc., Kingsport, Tenn.), ethylene glycol monobutyl ether acetate (commercially available as “Ektasolv® EB Acetate” from Eastman Chemical Products, Inc., Kingsport, Tenn.), diethylene glycol monobutyl ether acetate (commercially available as “Ektasolve® DB Acetate” from Eastman Chemical Products, Inc., Kingsport, Tenn.); water-immiscible phthalate plasticizers such as dibutyl phthalate, diethyl phthalate, dimethyl phthalate, dioctyl phthalate, dioctyl terephthalate, butyl octyl phthalate, butyl benzyl phthalate and alkyl benzyl phthalate commercially available as “Santicizer 261” from Monsanto Corp., St. Louis, Mo.; and other water-immiscible plasticizers such as dioctyl adipate, triethylene glycol di-2-ethylhexanoate, trioctyl trimellitate, glyceryl triacetate, glyceryl/tripropionin, 2,2,4-trimethyl-1,3-pentanediol diisobutyrate, HB-40 solvent (a partially hydrogenated terphenyl plasticizer commercially available from Monsanto Corp., St. Louis, Mo.) and “Mesamoll” solvent (an alkylsulfonic acid ester of phenol commercially available from Mobay Chemical Co., Pittsburgh, Pa.).

Other suitable water immiscible solvents include saturated hydrocarbons and unsaturated hydrocarbons, aromatic oils, paraffinic oils, extracted paraffinic oils, napthenic oils, extracted napthenic oils, hydrotreated light or heavy oils, vegetable oils, white oils, petroleum naphtha oils, halogen-substituted hydrocarbons, silicones and derivatives and mixtures thereof.

Hydrocarbons may be selected from straight chain or branched chain aliphatic hydrocarbons, alicyclic hydrocarbons and aromatic hydrocarbons. Examples of hydrocarbons are Saturated hydrocarbons such as n-hexane, isohexane, n-nonane, isononane, dodecane and isododecane; unsaturated hydrocarbons such as 1-hexene, 1-heptene and 1-octene; cyclic saturated hydrocarbons such as cyclohexane, cyclo heptane, cyclooctane, cyclodecane and decalin; cyclic unsaturated hydrocarbons such as cyclohexene, cycloheptene, cyclooctene, 1.3.5.7-cyclooctatetraene; and cyclododecene; and aromatic hydrocarbons such as benzene, toluene, Xylene, naphthalene, phenanthrene, anthracene and derivatives thereof.

In literature, the term paraffinic oil is often used. Suitable Paraffinic oils can be normal paraffin type (octane and higher alkanes), isoparaffins (isooctane and higher iso alkanes) and cycloparaffins (cyclooctane and higher cycloalkanes) and mixtures of paraffin oils.

The term “liquid paraffin” is often used to refer to a mixture of mainly including three components of a normal paraffin, an isoparaffin and a monocyclic paraffin, which is obtained by highly refining a relatively volatile lubricating oil fraction through a sulphuric acid washing or the like, as described in U.S. Pat. No. 6,730,153. The entire content of U.S. Pat. No. 6,730,153 is hereby incorporated by reference.

Suitable hydrocarbons are also described as de-aromatized petroleum distillates.

Suitable examples of halogenated hydrocarbons include methylene dichloride, chloroform, tetrachloromethane and methyl chloroform. Other suitable examples of halogen-substituted hydrocarbons include perfluoro-alkanes, fluorine based inert liquids and fluorocarbon iodides.

Suitable examples of silicone oils include dialkyl polysiloxane (e.g., hexamethyl disiloxane, tetramethyl disiloxane, octamethyl trisiloxane, hexamethyl trisiloxane, heptamethyl trisiloxane, decamethyl tetrasiloxane, trifluoropropyl heptamethyl trisiloxane, diethyl tetramethyl disiloxane), cyclic dialkyl polysiloxane (e.g., hexamethyl cyclotrisiloxane, octamethyl cyclotetrasiloxane, tetramethyl cyclotetrasiloxane, tetra(trifluoropropyl)tetramethyl cyclotetrasiloxane), and methylphenyl silicone oil.

As described in U.S. Pat. No. 8,287,112, white oil is a term used for white mineral oils, which are highly refined mineral oils that consist of saturated aliphatic and alicyclic non-polar hydrocarbons. The entire content of U.S. Pat. No. 8,287,112 is hereby incorporated by reference.

White oils are hydro phobic, colorless, tasteless, odorless, and do not change color over time. Vegetable oils include semi-drying oils such as soybean oil, cotton seed oil, Sunflower oil, rape seed oil, mustard oil, sesame oil and corn oil; non-drying oils such as olive oil, peanut oil and tsubaki oil; and drying oils such as linseed oil and safflower oil, wherein these vegetable oils can be used alone or as a mixture thereof.

Examples of other suitable oils include petroleum oils, non-drying oils and semi-drying oils. Commercially available suitable oils include the aliphatic hydrocarbons types such as the ISOPAR™ range (isoparaffins) and Varsol/Naphtha range from DOWN CHEMICAL, the SOLTROL™ range and hydrocarbons from CHEVRON PHILLIPS CHEMICAL, and the SHELLSOL™ range from SHELL CHEMICALS.

Suitable commercial normal paraffins include the NOR PAR™ range from EXXON MOBIL CHEMICAL.

Suitable commercial napthenic hydrocarbons include the NAPPAR™ range from EXXON MOBIL CHEMICAL.

Suitable commercial de-aromatized petroleum distillates include the EXXSOL™ D types from EXXON MOBIL CHEMICAL.

Suitable commercial fluoro-substituted hydrocarbons include fluorocarbons from DAIKIN INDUSTRIES LTD, Chemical Division.

Suitable commercial silicone oils include the silicone fluid ranges from SHIN-ETSU CHEMICAL, Silicone Division.

Suitable commercial white oils include WITCO™ white OS from CROMPTON CORPORATION.

Various surfactants and dispersants useful in inkjet inks are disclosed in Published US Patent Application Number 2018/0118963 and in Polimery, 2016, 61(11-12), 745-882. The entire content of Published US Patent Application Number 2018/0118963 is hereby incorporated by reference.

Surfactants and dispersants may be included in the dispersed phase and in the continuous phase of the inks. Surfactant can enhance the colloidal stability of the composition or change the interaction of the ink with either the printing substrate, such as a textile fabric, or with the ink printhead. Various anionic, cationic, and nonionic dispersing agents can be used in conjunction with the ink various ink phases, and these may be used neat or as a water solution.

In one embodiment, the surfactant is present in an amount ranging from 0.05% to 5%, e.g., an amount ranging from 0.1% to 5%, or from 0.5% to 2%, by weight relative to the total weight of the inkjet ink composition.

Representative examples of anionic dispersants or surfactants include, but are not limited to, higher fatty acid salts, higher alkyidicarboxylates, sulfuric acid ester salts of higher alcohols, higher alkyl-sulfonates, alkylbenzenesulfonates, alkylnaphthalene sulfonates, naphthalene sulfonates (Na, K, Li, Ca, etc.), formalin polycondensates, condensates between higher fatty acids and amino acids, dialkylsulfosuccinic acid ester salts, alkylsulfosuccinates, naphthenates, alkylether carboxylates, acylated peptides, α-olefin sulfonates, N-acrylmethyl taurine, alkylether sulfonates, secondary higher alcohol ethoxysulfates, polyoxyethylene alkylphenylether sulfates, monoglycylsulfates, alkylether phosphates and alkyl phosphates, alkyl phosphonates and bisphosphonates, included hydroxylated or aminated derivatives.

For example, polymers and copolymers of styrene sulfonate salts, unsubstituted and substituted naphthalene sulfonate salts (e.g. alkyl or alkoxy substituted naphthalene derivatives), aldehyde derivatives (such as unsubstituted alkyl aldehyde derivatives including formaldehyde, acetaldehyde, propylaldehyde, and the like), maleic acid salts, and mixtures thereof may be used as the anionic dispersing aids.

Salts include, for example, Na+, Li+, K+, Cs+, Rb+, and substituted and unsubstituted ammonium cations. Representative examples of cationic surfactants include aliphatic amines, quaternary ammonium salts, sulfonium salts, phosphonium salts, and the like.

Representative examples of nonionic dispersants or surfactants that can be used in ink jet inks include fluorine derivatives, silicone derivatives, acrylic acid copolymers, polyoxyethylene alkyl ether, polyoxyethylene alkylphenyl ether, polyoxyethylene secondary alcohol ether, polyoxyethylene styrol ether, ethoxylated acetylenic diols, polyoxyethylene lanolin derivatives, ethylene oxide derivatives of alkylphenol formalin condensates, polyoxyethylene polyoxypropylene block polymers, fatty acid esters of polyoxyethylene polyoxypropylene alkylether polyoxyethylene compounds, ethylene glycol fatty acid esters of polyethylene oxide condensation type, fatty acid monoglycerides, fatty acid esters of polyglycerol, fatty acid esters of propylene glycol, cane sugar fatty acid esters, fatty acid alkanol amides, polyoxyethylene fatty acid amides and polyoxyethylene alkylamine oxides.

Surfactants capable of undergoing polymerization, also referred to as surfmers, polymerizable surfactants, surface-active monomers, polymerizable emulsifiers, monomeric surfactants, or monomeric emulsifiers. Polymerizable surfactants act in emulsion polymerization both as a surfactant and as a co-monomer. Polymerizable surfactant simply builds into polymer structure and does not remain in the reaction mixture.

Surfmers consist of three parts: a hydrophobic moiety; a hydrophilic moiety; and a polymerizable moiety—usually a double bond. Surfmers can be anionic, cationic, or non-ionic. Surfmers can have various polymerizable moieties such as acrylic methacrylic, vinylbenzyl, and maleic. The polymerizable moiety can be localized either at the hydrophobic part of the surfmer, or at the hydrophilic part. The hydrophilic moieties in anionic surfmers include: phosphates, sulphates and carboxylates.

Suitable examples of commercially available anionic surfmers include ammonium polyoxyalkylene alkenyl ether sulfate (Latemul PD-104), from Kao Corporation, Emulsogen APS 100, APS104, APS100 S, and APG 2019 from Clariant, Maxemul 6106 and 6112 from Croda, E-Sperse RS-1596, RS-1618, RS-1684, RX-202 from Ethox, and Visiomer MPEG 750 MAW from Evonik.

In the case of non-ionic surfmers, the hydrophilic moiety is usually a poly (ethylene oxide) chain. Hydrophilic moieties can also be based on for example polyglycidol or glucose. The hydrophobic moiety is usually a long hydrocarbon or poly (propylene oxide) chain.

Suitable examples of commercially available non-ionic surfactants include Latemul PD-420, Latemul PD-430, Latemul PD-4305 and PD-450 from Kao Corporation, Emulsogen RAL 100, RAL 109, RAL 208, RAL 307, R100, R 208 and R307 from Clariant, Maxemul 5010 and 5011 from Croda, Bisomer EP100DMA, EP150DMA PEM63P HD from GEO SC and E-Sperse RS-1616, RS-1617, RX-201 from Ethox.

Various thermal polymerization initiators useful in inkjet printing are disclosed in U.S. Pat. No. 8,287,112. The entire content of U.S. Pat. No. 8,287,112 is hereby incorporated by reference

Thermal polymerization initiators initiate polymerization of monomers, oligomers, surfmers, pre-polymers and reactive polymers by forming free radicals when exposed to elevated temperature. The activity of a thermal initiator may be estimated by its half-life at a given temperature. As the temperature is increased, the half-life of the initiator decreases, and the concentration of free radicals generated by thermal breakdown of the initiator increases. The activation temperature for a thermal initiator plays an important role in the free radical polymerization of monomers. Based on the amount of time available for the polymerization, the temperature of the polymerization should be equal to or greater than the activation temperature of the thermal initiator. At the activation temperature, at least half of the initiator will have thermally broken down to create free radicals within the time available for polymerization. In other words, the half-life of the thermal initiator at the activation temperature is equal to the minimum available time for polymerization.

By way of example, if the free radical polymerization of monomers into high molecular weight polymers initiated with a thermal initiator is to be completed within 3 minutes at 160° C., then the half-life of the thermal initiator should be no greater than 3 minutes at 160° C.

The activation temperature of thermal initiators varies based on their chemical structure. Some have very short half-lives at low temperatures and consequently have very low activations temperatures. However, such compounds are rather unstable and not suitable for inks requiring a modest shelf life.

Other thermal initiators have very long half-lives at high temperatures. Such initiators are very stable but require very high activation temperatures or very long polymerization times. Preferably, at the activation temperature of the thermal initiator the time available for polymerization will allow for 3 to 10 half-lives of the thermal initiator.

Free radical Polymerization proceeds via a chain mechanism, which basically consists of four different types of reactions involving free radicals: (1) radical generation from non-radical species (initiation), (2) radical addition to a substituted alkene (propagation), (3) atom transfer and atom abstraction reactions (chain transfer and termination by disproportionation), and (4) radical-radical recombination reactions (termination by combination). Classes of thermal polymerization initiators include organic initiators most commonly peroxide and azo compounds and inorganic initiators such as persulfates.

Suitable examples of peroxide thermal initiators that generate free radicals by cleavage of an O—O bond include tert-amyl peroxybenzoate, benzoyl peroxide, 2.2-bis(tert-butylperoxy)butane, 1,1-bis(tert-butylperoxy)cyclohexane, 1,1-bis(tert-butylperoxy)cyclohexane, 2.5-bis(tert-butylper oxy)-2,5-dimethylhexane, 2.5-bis(tert-butylperoxy)-2,5-dimethyl-3-hexyne, bis(1-(tert-butylperoxy)-1-methylethyl) benzene, 1,1-bis(tert-butylperoxy)-3,3,5-trim ethylcyclohexane, tert-butyl hydroperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2.4-pentanedione peroxide.

Suitable examples of azo thermal initiators that generate free radicals by cleavage of a N═N bond include 2,2′-azobisisobutyronitrile (AIBN), 4.4-azobis(4-cyanovaleric acid), 1,1′-azobis(cyclohexanecarbonitrile), 2,2′-Azodi(2-methylbutyronitrile), 1,1′-azobis(hexahydrobenzonitrile), 2,2′azobis(2-methylbutyronitrile), 2,2′-azobis-(amidinopropane) dihydrochloride, 2,2′-azobis(N, N′-dimethylene isobutyramidine dihydrochloride, dimethyl 2,2′-azobis(2-methylpropionate), 2,2′-azobis[2-(2-imidazolin-2-yl)-propane] dihydrochloride, and 2,2′-Azobis(2,4-dimethyl)valeronitrile.

Other suitable examples of organic thermal initiators include initiators that generate free radicals by means other than cleavage of O—O bonds or N═N bonds. Specific examples of other organic thermal initiators include nitroxides such as N-alkoxyam ines and N-acyloxyamines, more specifically 2,2,6,6-tetramethylpiperidinyl-1-oxy (TEMPO), N-tert-butyl-N-[1-diethylphosphono-(2,3dimethylpropyl)]nitroxide (SG1, DEPN), and N-tert-butyl-N-[1-phenyl-2-(methyl-propyl)]nitroxide (TIPNO).

Suitable examples of inorganic thermal initiators include ammonium persulfate, sodium persulfate, potassium persulfate, potassium monopersulfate, and hydroxymethanesulfinic acid monosodium salt dehydrate.

Various water miscible or water soluble co-solvents useful in inkjet inks are disclosed in Published US Patent Application Number 2018/0118963. The entire content of Published US Patent Application Number 2018/0118963 is hereby incorporated by reference.

The continuous aqueous phase comprises at least one organic solvent present in an amount ranging from 1% to 50% relative to the total weight of the inkjet ink composition. The amount of the solvent can be varied depending on a variety of factors, including the properties of the solvent (solubility and/or dielectric constant), the type of colorant, and the desired performance of the resulting inkjet ink composition. The solvent preferable used ranges from 1% to 40% by weight based on the total weight of the inkjet ink composition, and more preferably from 1% to 30%.

Examples of suitable organic solvents include low molecular-weight glycols (such as ethylene glycol, diethylene glycol, triethylene glycol, tetraethylene glycol, dipropylene glycol, ethylene glycol monomethyl ether, ethylene glycol monoethyl ether, triethylene glycol monomethyl or monoethyl ether, diethylene glycol monomethyl ether, diethylene glycol monoethyl ether, diethylene glycol monobutyl ether, and tetraethylene glycol monobutyl ether); alcohols (such as ethanol, propanol, iso-propyl alcohol, n-butyl alcohol, sec-butyl alcohol, and tert-butyl alcohol, 2-propyn-1-ol (propargyl alcohol), 2-buten-1-ol, 3-buten-2-ol, 3-butyn-2-ol, and cyclopropanol); diols containing from about 2 to about 40 carbon atoms (such as 1,3-pentanediol, 1,4-butanediol, 1,5-pentanediol, 1,4-pentanediol, 1,6-hexanediol, 1,5-hexanediol, 2,6-hexanediol, neopentylglycol (2,2-dimethyl-1,3-propanediol), 1,3-propanediol, 1,4-butanediol, 1,5-pentanediol, 1,6-hexanediol, 1,2,6-hexanetriol, and poly(ethylene-co-propylene) glycol, as well as their reaction products with alkylene oxides, including ethylene oxides, including ethylene oxide and propylene oxide); triols containing from about 3 to about 40 carbon atoms (such as glycerine (glycerol), trimethylolethane, trimethylolpropane, 1,3,5-pentanetriol, 1,2,6-hexanetriol, and the like as well as their reaction products with alkylene oxides, including ethylene oxide, propylene oxide, and mixtures thereof); polyols (such as pentaerythritol); amides (such as dimethyl formaldehyde and dimethyl acetamide); ketones or ketoalcohols (such as acetone and diacetone alcohol); ethers (such as tetrahydrofuran and dioxane); lactams (such as 2-pyrrolidone, N-methyl-2-pyrrolidone, and ε-caprolactam); ureas or urea derivatives (such as di-(2-hydroxyethyl)-5,5,-dimethyl hydantoin (dantacol) and 1,3-dimethyl-2-imidazolidinone); inner salts (such as betaine); and hydroxyamide derivatives (such as acetylethanolamine, acetylpropanolamine, propylcarboxyethanolamine, and propylcarboxy propanolamine, as well as their reaction products with alkylene oxides). Additional examples include saccharides (such as maltitol, sorbitol, gluconolactone and maltose); sulfoxide derivatives (symmetric and asymmetric) containing from about 2 to about 40 carbon atoms (such as dimethylsulfoxide, methylethylsulfoxide, and alkylphenyl sulfoxides); and sulfone derivatives (symmetric and asymmetric) containing from about 2 to about 40 carbon atoms (such as dimethylsulfone, methylethylsulfone, sulfolane (tetramethylenesulfone, a cyclic sulfone), dialkyl sulfones, alkyl phenyl sulfones, dimethylsulfone, methylethylsulfone, diethylsulfone, ethylpropylsulfone, methylphenylsulfone, methylsulfolane, and dimethylsulfolane). The organic solvent can comprise mixtures of organic solvents.

Various colorants useful in inkjet inks are disclosed in U.S. Pat. No. 8,287,112. The entire content of U.S. Pat. No. 8,287,112 is hereby incorporated by reference.

At least one of the non-aqueous dispersed phases contains at least one colorant. Colorants used in the inkjet inks may be pigments, dyes or a combination thereof.

The term “dye”, as used herein, means an oliophillic colorant having a solubility of 10 mg/L or more in the dispersed phase in which it is applied and under the ambient conditions pertaining.

Organic and/or inorganic pigments may be used in the non-aqueous dispersed phase of the inkjet textile ink. The inkjet textile inks preferably contain a pigment as colorant. If the colorant is not a self-dispersible pigment, the inkjet ink preferably also contain a dispersant, more preferably a polymeric dispersant.

Preferable, the pigment is encapsulated within the prepolymer oil of the dispersed phase of the inkjet textile ink emulsion.

Pigments may be dispersed in the continuous aqueous phase of the inkjet textile ink by dispersing agents, such as polymeric dispersants or surfactants. Additionally, the surface of the pigments can be modified to obtain so-called “self-dispersible” or “self-dispersing” pigments, i.e. pigments that are dispersible in the dispersion medium without dispersants.

The pigments in the aqueous inkjet textile inks may be black, white, cyan, magenta, yellow, red, orange, violet, blue, green, brown, mixtures thereof, and the like. The color pigment may be chosen from those disclosed by HERBST, Willy, et al. Industrial Organic Pigments, Production, Properties, and Applications. 3rd edition. Wiley-VCH, 2004. ISBN 3527305769.

Preferred pigments are C.I. Pigment Yellow 1, 3, 10, 12, 13, 14, 17, 55, 65, 73, 74, 75, 83, 93, 97, 109, 111, 120, 128, 138, 139, 150, 151, 154, 155, 180, 185 and 213. More preferably, yellow pigments are C.I. Pigment Yellow 74, 128, 139, 150 155 and 213. Preferred pigments are C.I. Pigment Red 17, 22, 23, 41, 48:1, 48:2, 49:1, 49:2, 52:1, 57:1, 81:1, 81:3, 88, 112, 122, 144, 146, 149, 169, 170, 175, 176, 184, 185, 188, 202, 206, 207, 210, 216, 221, 248, 251, 254, 255, 264, 270 and 272. Preferred pigments are C.I. Pigment Violet 1, 2, 19, 23, 32, 37 and 39. Preferred pigments are C.I. Pigment Blue 15:1, 15:2, 15:3, 15:4, 15:6, 16, 56, 61, and (bridged) aluminum phthalocyanine pigments. Preferred pigments are C.I. Pigment Orange 5, 13, 16, 34, 40, 43, 59, 66, 67, 69, 71 and 73. Preferred pigments are C.I. Pigment Green 7 and 36. Preferred pigments are C.I. Pigment Brown 6 and 7. Suitable pigments include mixed crystals of the above particular preferred pigments. A commercially available example is Cinquasia Magenta RT-355-D from Ciba Specialty Chemicals.

Carbon black is preferred as a pigment for the black inkjet ink. Suitable black pigment materials include carbon blacks such as Pigment Black 7 (e.g. Carbon Black MA80 from MITSUBISHI CHEMICAL), REGAL® 400R, MOGUL® L, ELFTEX® 320 from CABOT Co., or Carbon Black FW18, Special Black 250, Special Black 350, Special Black 550, PRINTEX® 25, PRINTEX® 35, PRINTEX® 55, PRINTEX® 90, PRINTEX® 150T from DEGUSSA.

Additional examples of suitable pigments are disclosed in U.S. Pat. No. 5,389,133. Particular preferred pigments are C.I. Pigment White 1, 2, 3, 4, 5, 6, 7, 10, 11, 12, 14, 17, 18, 19, 21, 24, 25, 27, 28, and 32. The entire content of U.S. Pat. No. 5,389,133 is hereby incorporated by reference.

A preferred white pigment is Pigment White 6 or titanium dioxide. Titanium oxide occurs in the crystalline forms of anatase type, rutile type and brookite type. The anatase type has a relatively low density and is easily ground into fine particles, while the rutile type has a relatively high refractive index, exhibiting a high covering power. Either one of these is usable.

It is preferred to make the most possible use of characteristics and to make selections according to the use thereof. The use of the anatase type having a low density and a small particle size can achieve superior dispersion stability, ink storage stability and ejectability. At least two different crystalline forms may be used in combination. The combined use of the anatase type and the rutile type which exhibits a high coloring power can reduce the total amount of titanium oxide, leading to improved storage stability and ejection performance of ink. For surface treatment of the titanium oxide, an aqueous treatment or a gas phase treatment is applied, and an alumina-silica treating agent is usually employed. Untreated-, alumina treated- or alumina-silica treated-titanium oxide are employable.

It is also possible to make mixtures of pigments in the color inkjet inks. For some applications, a neutral black inkjet ink is preferred and can be obtained, for example, by mixing a black pigment and a cyan pigment into the ink. Also non-organic pigments may be present in the color inkjet inks. Particular preferred pigments Illustrative examples of the inorganic pigments include red iron oxide (III), cadmium red, ultramarine blue, Prussian blue, chromium oxide green, cobalt green, amber, titanium black and synthetic iron black.

Specific examples of commercially available pigment dispersions include Pro-Jet Cyan APD1000, Pro-Jet Magenta APD1000, Pro-Jet Yellow APD1000, Pro-Jet Yellow(LF) APD1000, Pro-Jet Black APD1000 from Fujifilm Imaging Colorants, Inc., Cab-O-Jet 200 black, Cab-O-Jet 250C cyan, Cab-O-Jet 260M magenta, Cab-O-Jet 265M magenta, Cab-O-Jet 270 yellow, Cab-O-Jet 300 black, Cab-O-Jet 352 black, Cab-O-Jet 400 black, Cab-O-Jet 450C cyan, Cab-O-Jet 465M magenta, Cab-O-Jet 470Y yellow, Cab-O-Jet 480V violet, Cab-O-Jet 554B blue, Cab-O-Jet 740Y yellow, from Cabot Corporation, Specialty Cyan Dispersion Type A1, Specialty Cyan Dispersion Type A1, Specialty Cyan Dispersion Type A1, Specialty Cyan Dispersion Type P1, Specialty Cyan Dispersion Type P2, Specialty Magenta Dispersion Type A1, Specialty Magenta Dispersion Type A2, Specialty Magenta Dispersion Type A3, Specialty Magenta Dispersion Type P1, Specialty Magenta Dispersion Type P3, Specialty Yellow Dispersion Type A1, Specialty Yellow Dispersion Type A2, Specialty Yellow Dispersion Type P1, Specialty Yellow Dispersion Type P2, Specialty Black Dispersion Type A1, Specialty Black Dispersion Type P2, Specialty Black Dispersion Type P4, Specialty Black Dispersion Type SD2, Specialty Black Dispersion Type SD4, Specialty Red Dispersion Type P1, Specialty Green Dispersion Type P1, Specialty Green Dispersion Type P2, Specialty Green Dispersion Type P3, Specialty Green Dispersion Type P4, Specialty Orange Dispersion Type P1, Specialty Violet Dispersion Type P1, Specialty White Dispersion Type P1, from Eastman Kodak Company, Mega Cyan, Mega Magenta, Mega Yellow 2, Mega Black, DU 1010 cyan, DU 1020 magenta, DU 1030 yellow, DU 1031 yellow, DU 1040 black, DU 1041 black, from E. I. du Pont de Nemours and Company Cylcojet Blue 15:3 Liquid, Cylcojet Blue 15:3 Liquid, Cylcojet Blue 15:3 Liquid, Cylcojet Blue 15:0 & 15:4 Liquid, Cylcojet Blue 60 Liquid, Cylcojet Brown 25 Liquid, Cylcojet Red 122 Liquid Blue Shade, Cylcojet Red 122 Liquid Yellow Shade, Cylcojet Black 7 Liquid, Cylcojet Violet 19 Liquid Blue Shade, Cylcojet Violet 19 Liquid Yellow Shade, Cylcojet Yellow 74 & 155 Liquid, Cylcojet Orange 34 & 43, Cylcojet White 6 Liquid, from Lever Colors, Inc., Hostajet Yellow 4G-PT VP2669, Hostajet Red D3G-PT VP 5152, Hostajet Magenta E5B-PT VP3565, Hostajet Magenta E7B-PT VP 5122, Hostajet Magenta E-PT, Hostajet Cyan BG-PT, Hostajet Green 8G-PT VP 5154, Hostajet Black O-PT, from Clariant International, Ltd.

Pigment particles in inkjet ink should be sufficiently small to permit free flow of the ink through the inkjet-printing device, especially at the ejecting nozzles. It is also desirable to use small particles for maximum color strength and to slow down sedimentation.

When measured by a laser diffraction particle sizing apparatus such as the Horiba LA-950 and the like, the volume average pigment particle size of a dispersed non-white pigment is preferably between 0.020 and 1 μm, more preferably between 0.040 and 0.200 μm and particularly preferably between 0.050 and 0.150 μm. Most preferably, the numeric average pigment particle size is no larger than 0.100 μm. For the white pigment dispersion when measured by a laser diffraction particle sizing apparatus such as the Horiba LA-950 and the like, the volume average pigment particle size of the white pigment is preferably from 50 to 500 nm, more preferably from 150 to 400 nm, and most preferably from 200 to 350 nm. Sufficient hiding power cannot be obtained when the average diameter is less than 50 nm, and the storage ability and the jet-out suitability of the ink tend to be degraded when the average diameter exceeds 500 nm.

The pigment is preferably used in the pigment dispersion used for preparing the inkjet inks in an amount of 10 to 40 wt %, preferably 15 to 30 wt % based on the total weight of the pigment dispersion. In the inkjet ink the pigment is preferably used in an amount of 0.1 to 20 wt %, preferably 1 to 10 wt % based on the total weight of the inkjet ink.

The non-aqueous dispersed phase and the continuous aqueous phase of the inkjet textile ink may optionally comprise a polymeric resin. The polymeric resin can either be dissolved in the continuous aqueous phase or be dispersed in the continuous aqueous phase in the form of particles otherwise known as emulsion or latex form resin polymer.

The polymeric resin may comprise monomers, oligomers (short chains of about 10-100 monomers), polymers and copolymers of acrylates, acrylamides and other derivatives of acrylic acid, acryl/styrene, polyethylene-glycols, urethanes and polyvinylpyrrolidones, and the like also in the form of resin emulsions and co-emulsions. These polymeric resins can also be selected to have a relatively low glass transition temperature (Tg) and a bulk viscosity which does not exceed 1×10⁷ cP under the temperature conditions of the textile drying process, Step 14 of process 5 in FIG. 1.

When selected to have a low Tg, according to embodiments herein, polymeric resins which are commercially available, include without limitation, Hauthane™ series from C. L. Hauthaway & Sons Corp., Bondthane™ series from Bond Polymers, NeoRez™ and NeoCryl™ series from Royal DSM N.V., Luciden™ series from Hydrite Chemical Company, Plextol™ R 123 from Synthomer, Dispertex™ series from Diamond, Takelac™ series from Mitsui Chemicals America, Inc., AC and U series from Alberdingk Boley, Inc., R series from Essential Polymers, Texicryl™ series from Scott Bader, Ltd., Appretan™ series from Clariant, Hycar®, Hystretch®, Permax®, and Sancure® series from Lubrizol Corporation, Encor® series from Arkema, Inc., Arolon® series from Reichhold, Michem® series from Michelman, Inc., RUCO-COAT®, RUCO-PUR®, and RUCO-BOND® series from Rudolf-Duraner, Joncryl® series from BASF, and Witcobond® series from LANXESS.

U.S. Pat. No. 9,611,401 discloses various crosslinking agents useful in inkjet inks. The entire content of U.S. Pat. No. 9,611,401 is hereby incorporated by reference.

As used herein, the phrase “crosslinking agent” refers to a substance that promotes or regulates intermolecular covalent, ionic, hydrophobic or other form of bonding between polymer chains, linking them together to create a network of chains which result in a more elastic and/or rigid structure. Crosslinking agents, contain at least two reactive groups that can interact with respective groups present in the polymerizable constituents of the ink composition and/or on the surface of the textile fiber.

Exemplary such reactive groups include, but are not limited to, amine groups, carboxyl groups, hydroxyl groups, isocyanate groups, blocked isocyanate groups, epoxy groups, acid chloride groups, double bonds, acrylates, acrylamides, organic titanates, zirconates, and sulfhydryl groups. Crosslinking agents include homo-bifunctional crosslinking agents that have two identical reactive end groups, and hetero-bifunctional crosslinking agents which have two different reactive end groups.

These two classes of crosslinking agents differ primarily in the chemical reaction which is used to affect the crosslinking step, wherein homo-bifunctional crosslinking agents will require a one-step reaction, and hetero-bifunctional crosslinking agents may require two steps to affect the same. While homo-bifunctional crosslinking agents have the tendency to result in self-conjugation, polymerization, and intracellular crosslinking, hetero-bifunctional agents allow more controlled two step reactions, which minimizes undesirable intramolecular cross reaction and polymerization. Crosslinking agents are further characterized by different spacer arm lengths. A crosslinking agent with a longer spacer arm may be used where two target groups are further apart and when more flexibility is desired.

Water insoluble crosslinking agents may be incorporated into the liquid prepolymer oil of the non-aqueous dispersed phase of the inkjet textile ink. Water insoluble crosslinking agents may also be dispersed into the continuous aqueous phase of the inkjet textile ink. Water insoluble crosslinking agents may be dissolved or dispersed into water immiscible solvents and emulsified into the continuous aqueous phase of the inkjet textile ink. Additionally, water miscible or water soluble crosslinking agents may be dissolved in the continuous aqueous phase of the inkjet textile ink.

Regardless of prepolymer oil composition or the type of crosslinking agent or how the crosslinking agent is incorporated into the inkjet textile ink, any bonding between ink and the textile fiber depends substantially on the type of fiber, or more specifically, on the physical and chemical micro-structure of the fiber surface, and the availability of reactive functional groups on the surface of the fiber, namely its chemical composition.

Cellulosic materials, such as many fabrics made at least a partially from natural fibers (cotton, hemp), wool, silk and even skin and leather, offer a variety of available and reactive functional groups such as hydroxyl, carboxyl, thiol and amine groups, which can be tethered to the ink via the crosslinking agent.

Alternatively, in cases on some fibers such as synthetic polymeric fibers, the scarcity of reactive functional groups means that the bonding of the ink to the substrate is afforded by mechanical properties and micro-structure of the fiber surface, namely affixation by polymeric adhesion and physical interweaving and entanglement.

Polymerization and crosslinking of the prepolymer oil will affect the elasticity of the dried and cured inkjet printed textile image. The resulting modification of mechanical properties of the cured ink formed on the fiber depends on the crosslink density, i.e., low crosslink densities raise the viscosities of semi-fluid polymers, intermediate crosslink densities transform gummy polymers into materials that have elastomeric properties and potentially high strengths, and highly crosslink densities can cause materials to become rigid, glassy and low in elongation to break.

The crosslink density of the cured inks, which constitutes the colorants attached to and encapsulated by the crosslinked polymer, stems primarily from the concentration of the crosslinking agent in the pre-polymerization mixture, which constitute the ink composition once all its parts are adjoined on the textile fiber surface. Hence, the level of crosslink density of the cured ink composition is an intermediate level which affords a highly pliable, stretchable, and elastic coating on the textile fiber surface.

Formaldehyde is a functional crosslinking agent for many polymers. However, textile inks containing formaldehyde are restricted for use in certain applications, based on formaldehyde content of the garment according to Oko-Tex Standard 100 (Oko-Tex). Although formaldehyde, which forms upon use of amino resin crosslinking agents, may evaporate from the garment at high temperatures, the levels of formaldehyde can never reach the allowed values according to the widely accepted Oko-Tex Standard 1000.

Crosslinking agents includes dialdehydes, other polyaldehydes or dialdehyde acid analogues having at least one aldehyde group, such as, for example, C2-C8 dialdehydes. Alkylated glyoxal/cyclic urea condensates serve as crosslinkers for cellulosic fibers and various active hydrogen containing polymers.

U.S. Pat. Nos. 4,285,690; 4,345,063; and 4,888,093 disclose several crosslinking agents useful in inkjet printing. The entire contents of U.S. Pat. Nos. 4,285,690; 4,345,063; and 4,888,093 are hereby incorporated by reference.

Crosslinking agents may include heteroaryl polycarbamate crosslinking agents which are based on a moiety derived from the group consisting of linear or cyclic ureas, cyanuric acid, substituted cyanuric acids, linear or cyclic amides, glycolurils, hydantoins, linear or cyclic carbamates and mixtures thereof are suitable as crosslinker agents between the ink composition and the cellulosic fabrics.

U.S. Pat. Nos. 6,063,922; 5,596,047; and 7,381,347 and Published US Patent Application Number 2004/0116558 disclose several crosslinking agents useful in inkjet printing. The entire contents of U.S. Pat. Nos. 6,063,922; 5,596,047; and 7,381,347 and Published US Patent Application Number 2004/0116558 are hereby incorporated by reference.

Crosslinking agents may include diacetone acrylamide/hydrazine (polyalkenyl ether resins), disclosed in U.S. Pat. Nos. 5,348,997; 5,432,229; and 7,119,160, for example N-(1,1-dimethyl-3-oxobutyl)-acrylamide(DAAM)/hydrazine by Kyowa Hakko Chemical Co., Ltd., Japan. The entire contents of U.S. Pat. Nos. 5,348,997; 5,432,229; and 7,119,160 are hereby incorporated by reference.

Crosslinking agents may include carbodiimides, which are comprise of functional groups having of the formula —N═C═N— and which can react readily with amine and carboxyl groups are disclosed in Patent Application Kokai (Laid-Open) No. 187029/1984, Published US Patent Application Number 2007/0148128; U.S. Pat. Nos. 5,360,933; 6,124,398; 7,425,062; and European Patent Number EP0277361. A non-limiting example of such crosslinking agents includes CARBODILITE® by Nashinbo, Japan. The entire contents of Published US Patent Application Number 2007/0148128; U.S. Pat. Nos. 5,360,933; 6,124,398; 7,425,062; and European Patent Number EP0277361 are hereby incorporated by reference.

The means to achieve the crosslinking of a prepolymer generally relies on at least one component of the starting material and/or intermediate having 3 or more functional reaction sites.

Published US Patent Application Number 2007/0060670 discloses several multifunctional monomers useful in inkjet printing. The entire content of Published US Patent Application Number 2007/0060670 is hereby incorporated by reference.

Reaction of each of the 3 (or more) reaction sites will produce a crosslinked polymer. When only two reactive sites are available on each reactive component, only linear polymers can be produced. Examples of crosslinking polymerization reactions capable of producing polyurethanes, for example, include but are not limited to the following: the isocyanate-reactive moiety has at least 3 reactive groups, for example polyfunctional amines or polyol; the isocyanate has at least 3 isocyanate groups; the prepolymer chain has at least 3 reactive sites that can react via reactions other than the isocyanate reaction, for example with amino trialkoxysilanes; addition of a reactive component with at least 3 reactive sites to the polyurethane prior to its use in the inkjet ink preparations, for example tri-functional epoxy crosslinkers; addition of a water-dispersible crosslinker with oxazoline functionality; synthesis of a polyurethane with carbonyl functionality, followed by addition of a dihydrazide compound; and any combination of the these crosslinking methods and other crosslinking means known to those of ordinary skill in the relevant art.

Blocked isocyanate crosslinkers include TMP (trimethylolpropane) adduct form or isocyanurate form of: HDI (hexamethylene diisocyanate), H6XDI (hydrogenated xylylene diisocyanate), IPDI (isophorone diisocyanate), or H12MDI (dicyclohexylmethane diisocyanate). Additionally, the blocking agent is preferably DEM (diethyl malonate), DIPA (diisopropylamine), TRIA (1,2,4-triazole), DMP (3,5-dimethylpyrazole), or MEKO (2-butanonoxime), which, however, are not to be construed as limiting.

Crosslinking agents may include difunctional acrylates include alkoxylated cyclohexanone dimethanol diacrylate, alkoxylated hexanediol diacrylate, dioxane glycol diacrylate, dioxane glycol diacrylate, cyclohexanone dimethanol diacrylate, diethylene glycol diacrylate and neopentylglycol diacrylate. Trifunctional acrylates include propoxylated glycerine triacrylate and ethoxylated or propoxylated trimethylolpropane triacrylate. Other higher functional acrylates include di-trimethylolpropane tetraacrylate, dipentaerythritol pentaacrylate, ethoxylated pentaeryhtitol tetraacrylate, methoxylated glycol acrylates and acrylate esters. 0078. Furthermore, methacrylates corresponding to the above-mentioned acrylates may be used with these acrylates. Of the methacrylates, methoxypolyethylene glycol methacrylate, methoxytriethylene glycol methacrylate, hydroxyethyl methacrylate, phenoxyethyl methacrylate, cyclohexyl methacrylate, tetraethylene glycol dimethacrylate, and polyethylene glycol dimethacrylate are preferred due to their relatively high sensitivity and higher adhesion to a textile fiber surface.

The ink composition optionally contain one or more other ingredients, such as, buffering/neutralizing agents, adhesion promoters, bactericides, fungicides, algicides, sequestering agents, softeners, thickeners, anti-foaming agents, anti-kogation agents, corrosion inhibitors, light stabilizers, anti-curl agents, thickeners, non-reactive agents, softeners/plasticizers, specialized dispersing agents, specialized Surface active agents, conductivity agents (ionizable materials) and/or other additives and adjuvants well-known in the relevant art.

pH adjusting agents include, inorganic and organic water soluble acids and inorganic and water soluble bases, and amphoteric compounds. Non-limiting examples include sodium hydroxide, potassium hydroxide, ammonium hydroxide, primary, secondary and tertiary amines such as triethanolamine, triethyamine, dimethyl ethanolamine, 2-amino-2-methyl-1-propanol, amino acids such as tris(hydroxymethyl amino methane), hydrochloric acid, sulfuric acid, phosphoric acid, nitric acid, acetic acid, propionic acid and the like.

Non-limiting examples of anti-foaming agents (defoamer) include BYK 024, BYK 012: BYK 31 (commercially available from Byk-Chemie), FOAMEX 810, AIREX 901, AIREX 902 (commercially available from Evonik Tego Chemie GmbH, Essen, Germany), SURFYNOL DF 37, SURFYNOL DF 210, SURFYNOL DF 75 (commercially available from Air Products Ltd.), and the like.

Printed and cured images on textiles with these inks enable the textile to retain its hand, feel, stiffness, and texture. Printed textile images are wash-fast, resistant to fading and abrasion. Additionally, the printed textile images will be very low in unreacted monomer or oligomer content and contain no photo-initiators or their degradation products.

These inks can easily fit into existing fabric printing workflows. Fabric pretreatments are not required, nor is a UV curing lamp. The inks are cured within the usual drying presses and ovens typically employed in textile printing processes.

Textile fibers are often hydroxyl-containing material. Cellulosic fiber materials that consist wholly or partly of cellulose are preferred. Examples are natural fiber materials such as cotton, linen, hemp, wool or silk and regenerated fiber materials such as viscose and rayon. Synthetic fibers include polyacrylates, polyesters, polyacrylonitrile, polyamide, aramid, polypropylene, and polyurethane. The fiber materials mentioned are preferably present as sheet-like textile wovens, knits, or webs.

After printing, the inkjet printed textile fabric is advantageously dried, preferably at temperatures up to 150° C., especially 60 to 120° C. The liquid prepolymer oils of the inkjet textile ink wet-out and coat the fibers of the textile as well as the colorants. The state of the prepolymer oil can then be changed from a liquid to a solid by triggering the polymerization and/or crosslinking of the prepolymer oil by a heat treatment, which is preferably carried out at a temperature 80 to 190° C. for preferably between 30 seconds to 10 minutes. The trigger temperature for polymerization and/or crosslinking is determined by the chemical characteristics of the polymerization initiator and/or crosslinker.

The state of the prepolymer oil can also be changed from a liquid to a solid by triggering the polymerization and/or crosslinking of the prepolymer oil by irradiation with electron beams. Advantageously, the printed textiles can be polymerized and/or crosslinked by irradiation at an elevated temperature, for example between 40 and 120° C., in particular between 60 and 100° C.

The irradiation may either take place during or immediately after the drying process, or one can also heat the cold printed fiber material before irradiation to the desired temperature, for example in an infrared heater.

The polymerization and/or crosslinking with electron beam is generally carried out such that a printed and dried process has the textile fiber material being passed through the beam of an electron accelerator at temperatures between 20 and 150° C. This is done at such a rate that a specific electron beam dose is achieved. Typical electron beam doses are between 1 and 150 kGy, at an accelerating voltage of 100-200 kV. The electron beam dose is advantageously between 1 and 40 kGy. At a dose of less than 1 kGy, the degree of polymerization and/or crosslinking too low, leading to unacceptable levels of residual monomer and oligomer. At electron beam doses of more than 150 kGy, damage to the fiber material and the pigment may occur. The trigger dosage is determined by the chemical characteristics of the polymerizable materials and/or crosslinkers.

### EXAMPLES

The following examples illustrate a number of embodiments of the present invention that are presently known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the acceptable embodiments.

Exemplary aqueous inkjet emulsion inks are prepared comprising non-aqueous components emulsified and/or dispersed in a continuous aqueous phase. In a preferred embodiment, an inkjet ink is prepared by combining an emulsion comprising a liquid prepolymer oil dispersed in an aqueous vehicle with a dispersed pigment colorant and a polymerization initiator or crosslinker.

### Example 1

An aqueous inkjet emulsion ink comprising a pigment colorant dispersion encapsulated in the non-aqueous phase was prepared following a step by step process. First an aqueous vehicle was formed by mixing 122.45 of a reverse osmosis deionized (RODI) water with 1.55 g of sodium dodecyl sulfate until fully dissolved and then 0.08 g of Surfynol DF-58 antifoamant additive (available from Evonik America, 299 Jefferson Rd, Parsippany, N.J. 07054) was mixed into the vehicle

Second, the non-aqueous liquid was prepared by mixing until completely dissolved 15 g of 1,6-hexandiol dimethacrylate monomer (SR239 supplied by Sartomer USA 502 Thomas Jones Way, Exton, Pa. 1934) with 15 g of polyester acrylate oligomer (CN2262 supplied by Sartomer USA, 502 Thomas Jones Way, Exton, Pa. 1934). To this mixture 1 g of 1,1′-Azobis(cyclohexane-1-carbonitrile) thermally activated polymerization initiator (V-40 supplied by FUJIFILM-Waco, Chemical Division Business Strategy Division, 2-4-1, Nihonbashi-honcho, Chuo-ku, Tokyo 103-0023) was added and mixed until completely dissolved.

Third, an emulsion of the non-aqueous liquid in the aqueous vehicle was prepared. In a 250 ml Pyrex beaker 31 g of the non-aqueous liquid was added to 124 g of the aqueous vehicle with mixing provided by Ultra-Turrax® Rotor-Stator Homogenizer to create a crude emulsion. The beaker containing the crude emulsion was then placed in an ice filled 1000 cc plastic beaker for sonication. The horn of a Fisher Scientific Model 500 Sonic Dismembrator was then placed into the crude emulsion. The crude emulsion was sonicated at 70% amplitude for 30 minutes until a mini-emulsion was formed with a mean non-aqueous liquid droplet size of less than 1 micron.

Forth, the inkjet emulsion ink was prepared by adding 30 g of the mini-emulsion to a 100 ml Pyrex beaker. To this was added 10 g of RODI water and 10 g of Cabojet Cyan pigment dispersion (COJ450C supplied Cabot Corporation, 157 Concord Road, Billerica, Mass. 01821). The mixture was stirred until all the components were thoroughly mixed.

Fifth, the dispersed pigment particles in the ink were encouraged to mix into and be encapsulated by the non-aqueous liquid phase of the mini-emulsion with sonication. The Pyrex beaker containing 50 g of the inkjet emulsion ink was placed in an ice filled 1000 cc plastic beaker. The horn of a Fisher Scientific Model 500 Sonic Dismembrator was placed into the inkjet emulsion ink to sonicate it for 10 minutes at 70% amplitude to encapsulate the pigment in the non-aqueous liquid phase.

Sixth, 9 grams of the inkjet emulsion ink from step five was combined with 1 g of ethylene glycol co-solvent and filtered through a 1 micron filter in preparation for inkjet printing.

### Example 2

The ink of Example 1 was reproduced with the exception that in step 4 of said example, 10 g of Cabojet Cyan pigment dispersion (COJ450C supplied Cabot Corporation, 157 Concord Road, Billerica, Mass. 01821) was replaced by 12.5 g of Specialty Cyan A1 (supplied by Kodak Corporation, 343 State St., Rochester, N.Y. 14650) and the amount of RODI water was decreased to 8 g.

### Example 3

The ink of Example 1 was reproduced with the exception that in step 4 of said example, the 10 g of Cabojet COJ450C Cyan pigment dispersion used in Step 4 of Example 1 was replaced with 10 g of Magenta pigment dispersion (COJ265M Magenta supplied by Cabot Corporation, 157 Concord Road, Billerica, Mass. 01821).

### Example 4

The ink of Example 1 was reproduced with the exception that the 1 g of 1,1′-Azobis(cyclohexane-1-carbonitrile V-40 thermally activated polymerization initiator used in Step 2 of Example 1 was excluded from this example and was replaced with the addition 0.035 g of 2,2′-Azobis[2-methyl-N-(2-hydroxyethyl)propionamide] (VA-86 supplied by FUJIFILM-Waco, Chemical Division Business Strategy Division, 2-4-1, Nihonbashi-honcho, Chuo-ku, Tokyo 103-0023) thermally activated polymerization initiator in step 6 of Example 1 by mixing into said inkjet emulsion ink.

### Example 5

An aqueous inkjet emulsion ink was prepared by mixing 9.18 g of a reverse osmosis deionized (RODI) water with 0.08 g of polyether modified silicone surfactant (BYK-348 from BYK-Chemie GmbH, P.O. Box 10 02 45, 46462 Wesel, Germany), 8.02 g of an acrylated polyurethane dispersion with a mean particle size <100 nm (UCECOAT 2801 supplied by Allnex Americas, 9005 Westside Parkway, Alpharetta, Ga. 30009), 2.5 g of ethylene glycol, 5 g of Cabojet COJ450C Cyan pigment dispersion and 0.10 g of 2,2′-Azobis[2-methyl-N-(2-hydroxyethyl)propionam ide] (VA-86 supplied by FUJIFILM-Waco, Chemical Division Business Strategy Division, 2-4-1, Nihonbashi-honcho, Chuo-ku, Tokyo 103-0023) thermally activated polymerization initiator until fully dissolved. The ink and filtered through a 1 micron filter in preparation for inkjet printing.

### Example 6

The ink of this example was prepared in an analogues fashion to the ink of Example 5 with the exception that UCECOAT 2802 acrylated polyurethane dispersion was substituted for the UCECOAT 2801 used in Example 5.

### Example 7

The ink of this example was prepared in an analogues fashion to the ink of Example 5 with the exception that the 10 g of Cabojet COJ450C Cyan pigment dispersion was replaced with 10 g of Cabot Magenta pigment dispersion COJ265M used in Example 5.

### Example 8

The ink of this example was prepared in an analogues fashion to the ink of Example 5 with the exception that the 10 g of Cabojet COJ450C Cyan pigment dispersion was replaced with 10 g of Cabot Yellow pigment dispersion COJ470Y used in Example 5.

### Example 9

The ink of this example was prepared in an analogues fashion to the ink of Example 5 with the exception that the 10 g of Cabojet COJ450C Cyan pigment dispersion was replaced with 10 g of Cabot Black pigment dispersion COJ300 used in Example 5.

### Example 10 Control

The control ink of this example was prepared without a non-aqueous liquid emulsion and without a polymerization initiator or crosslinker. The aqueous inkjet emulsion ink was prepared by mixing 17.25 of a reverse osmosis deionized (RODI) water 0.0.25 g of sodium dodecyl sulfate, 2.55 g of ethylene glycol, and 5 g of Cabojet COJ450C Cyan pigment dispersion until fully mixed and filtered through a 0.1 micron filter in preparation for inkjet printing. This example serves as a control to compare the durability of an inkjet emulsion ink with and without the emulsion/curing agent, which when cured and/or crosslinked anchors the pigment colorant to the textile fibers.

### Control Example 11(K)

The ink of Example 1 was reproduced with the exception that the of 1,1′-Azobis(cyclohexane-1-carbonitrile) V40 thermally activated polymerization initiator was not added to the ink of this example. This example serves as a control to demonstrate the utility the polymerization initiator plays in an inkjet emulsion ink and specifically the impact of said polymerization initiator on the durability of an image printing with said inkjet ink onto a textile and then cured above the trigger temperature of said polymerization initiator. Example inks were inkjet printed, one at a time, using an Epson C88+ desktop printer with a piezo type print head. Example inks were loaded into Epson compatible Inkjet cartridges. Each ink was purged into the printer with 5 printer cleaning cycles. Using an Adobe Photoshop printer driver (available from Adobe, 345 Park Avenue, San Jose, Calif. 95110-2704) set to a relative colorimetric rendering and a 600 DPI resolution solid monochrome blocks of each ink were printed onto a 3″×6″ textile substrates adhesively attached to an 8.5″×11″ sheet of printer paper. Each print contained one 1″×4.5″ monochrome color block and three 1″×1″ monochrome color blocks. The printed textile examples were then heated in a textile heat press for 5 minutes.

Textile samples used in print and durability testing included Cotton Heritage: MC1082 enzyme-washed 100% ring-spun combed Cotton and Wuji polyester: Wuji White Jet Set 100% polyester knit.

After thermally treating the printed textile examples of this instant invention, each printed example was measured for color reflection density (Rd) using a PIAS2 personal image analysis system (supplied by QEA of 755 Middlesex Turnpike, Unit 3, Billerica, Mass. 01821) set to a 2 degree observer angle and D5000. Each example was then subjected to dry rub fastness to and wash fastness testing.

Wash Fastness Test 1 testing was conducted on each printed textile sample. In a 600 ml Pyrex beaker, 5.0 g of Tide Original HE (high efficiency) liquid detergent was mixed into 495.0 g of tap water. The detergent solution was heated to 50° C. and mixed at 250 rpm with a magnetic stir bar. 1″×1″ printed textile samples were added to beaker and washed for 45 minutes. The samples were then removed from the detergent solution and dried in an oven at 60° C. for 30 minutes. After drying, reflection density was re-measured on each sample. Three wash and dry cycles were performed on each printed textile sample. Durability was assessed by the percentage change in the reflection density of the inkjet printed and cured section of each sample.

Wash Fastness Test 2 was conducted in a fashion similar to Test 1 with the exception that the wash temperature was increased to 70° C. and one wash cycle was conducted for 3 hours. Note that some of the printed cotton samples exhibited some shrinkage in this text method which may have contributed to higher reflection densities post washfastness testing due to the decreased area of the printed region.

Examples were rated as excellent (•) if their reflection density did not decrease after wash fastness testing. Examples were rated as good (∘) if their reflection density did not decrease by more than 0.02 after wash fastness testing. Examples were as fair (Δ) if their reflection density decreased after wash fastness testing by more than 0.02 but less than or equal to 0.05. Examples were rated as poor (x) if their reflection density decreased after wash fastness testing by more than 0.05.

Dry rub fastness was measured for each of the printed textile sample using the ISO 105 X12 standard testing method (available from International Organization for Standardization, ISO Central Secretariat, BIBC II, Chemin de Blandonnet 8, CP 401, 1214 Vernier, Geneva, Switzerland). In this procedure 4.5″ long inkjet printed and cured samples were subjected to a dry rub abrasion with a standard cloth using a load of 9 N for 10 cycles over 10 seconds. Reflection densities were measured on both the printed sample and the standard cloth both before and after rubbing. Examples were rated as excellent (•) if the reflection density picked up by the standard rub cloth was less than 8% of the reflection density of the unrubbed example. Examples were rated as good (∘) if the reflection density picked up by the standard rub cloth was between 8% and 12% of the reflection density of the unrubbed example. Examples were as fair (Δ) if the reflection density picked up by the standard rub cloth was between 12% and 16% of the reflection density of the unrubbed example. Examples were rated as poor (x) if the reflection density picked up by the standard rub cloth was greater than 16% of the reflection density of the unrubbed example.

Table 1 summarizes the print reflection density, dry rub fastness and wash fastness of each of the examples which had been inkjet printed either onto cotton or polyester textiles and thermally cured under the conditions noted in Table 1. Examples 1 to 9 demonstrate that if the printed example inks are cured at or above the activation temperature of the thermal initiator for a sufficient period time that good rub and wash fastness can be achieved. The control examples demonstrate that if the curing temperature of the printed textile is below the activation temperature of the thermal initiator then poor rub and wash fastness is observed. The control examples also demonstrate that if the curing time of the printed textile at the activation temperature of the thermal initiator is insufficient, then poor rub and wash fastness is observed. Additionally, if a thermal initiator is not included in the ink, as in Example 11, then a decrease in rub and wash fastness is observed compared to the equivalent example containing a thermal initiator, as in Example 1.

TABLE 1

| | | cure temp. | cure time | print | | Wash Fastn. | Wash Fastn. |
|---|---|---|---|---|---|---|---|
| Examples | fabric | (° C.) | (Sec.) | density | dry rub % | Test 1 | Test 2 |
| Invention | | | | | | | |
| 1 | 100% cotton | 165 | 300 | 1.33 | ◯ | ● | ● |
| 2 | 100% cotton | 165 | 300 | 1.47 | Δ | ◯ | Δ |
| 3 | 100% cotton | 165 | 300 | 0.81 | X | Δ | Δ |
| 4 | 100% cotton | 165 | 300 | 1.41 | Δ | Δ | ● |
| 5 | 100% cotton | 165 | 300 | 1.33 | ● | ● | ● |
| 6 | 100% cotton | 165 | 300 | 1.41 | ● | ● | Δ |
| 7 | 100% cotton | 165 | 300 | 0.79 | ● | ● | ● |
| 8 | 100% cotton | 165 | 300 | 0.86 | ● | ◯ | ◯ |
| 9 | 100% cotton | 165 | 300 | 1.03 | ● | ● | ● |
| 1 | 100% polyester | 165 | 300 | 0.99 | ◯ | ● | |
| 5 | 100% polyester | 165 | 300 | 1.14 | ● | ◯ | |
| Comparison | | | | | | | |
| 1 | 100% cotton | 60 | 300 | 1.39 | X | X | |
| 1 | 100% cotton | 100 | 300 | 1.31 | X | X | |
| 1 | 100% cotton | 160 | 1 | 1.29 | X | | |
| 1 | 100% cotton | 160 | 10 | 1.35 | X | | |
| 1 | 100% cotton | 160 | 60 | 1.29 | X | | |
| 1 | 100% polyester | 110 | 300 | 0.98 | X | | |
| 10 | 100% cotton | 165 | 300 | 1.12 | X | X | X |
| 11 | 100% cotton | 165 | 300 | 1.38 | ◯ | Δ | X |
| 11 | 100% polyester | 165 | 300 | 1.00 | Δ | ◯ | |

| | | | | |
|---|---|---|---|---|
| criteria: | excellent ● | good ◯ | fair Δ | poor X |
| dry rub rating: | <=8 | 8 to 12 | 12 to 16 | >16 |
| Wash Fastness Rating: | >0.00 | 0.00 to −.02 | −.02 to −.05 | >−0.05 |

In summary, an aqueous inkjet ink for direct printing onto textiles comprises a non-aqueous dispersed liquid phase; a continuous aqueous phase; a thermal initiator; and a colorant; the continuous aqueous phase being comprised of water, a water miscible organic solvent, and a surfactant; the non-aqueous liquid phase, dispersed in the continuous aqueous phase, being comprised of prepolymer liquid wherein the state of the prepolymer liquid irreversibly changes from a liquid to a solid in response to application of heat.

The thermal initiator may be hydrophobic. The non-aqueous liquid phased may contain the thermal initiator. The non-aqueous thermal initiator may be initially dissolved in a hydrophobic solvent and emulsified into the aqueous inkjet ink. The thermal initiator may be dispersed in the aqueous inkjet ink. The aqueous continuous phase may contain the thermal initiator. The thermal initiator may be soluble in the aqueous continuous phase. The continuous aqueous phase may have a viscosity in the range of 1 to 100 cP at 25° C. The prepolymer liquid may have a viscosity in the range 1 cP to 1×10⁷ cP at 25° C. The application of heat may cause the prepolymer liquid to convert to a high viscosity solid polymer. The application of heat may be at a temperature greater than 60° C. A half-life of the thermal initiator may be less than or equal to a minimum available time for polymerization of the prepolymer liquid. Three to ten half-lives of the thermal initiator may fit within a minimum available time for polymerization of the prepolymer liquid. The application of heat may be at a temperature greater than 100° C. and the application of heat is applied for more than 10 seconds.

An aqueous inkjet ink for direct printing onto textiles comprises a non-aqueous dispersed liquid phase; a continuous aqueous phase; and a colorant; the continuous aqueous phase being comprised of water, a water miscible organic solvent, and a surfactant; the non-aqueous liquid phase, dispersed in the continuous aqueous phase, being comprised of prepolymer liquid wherein the state of the prepolymer liquid irreversibly changes from a liquid to a solid in response to irradiation of electron beams.

The continuous aqueous phase may have a viscosity in the range of 1 to 100 cP at 25° C. The prepolymer liquid may have a viscosity in the range 1 cP to 1×10⁷ cP at 25° C. The irradiation of electron beams may be at a dosage between 1 kGy and 150 kGy. The irradiation of electron beams may be at a dosage is between 10 kGy and 50 kGy.

A process for printing a textile comprises (a) printing a textile with an aqueous ink to create an inked textile, the aqueous ink including a non-aqueous dispersed liquid phase, a continuous aqueous phase, and a colorant, the continuous aqueous phase being comprised of water, a water miscible organic solvent, and a surfactant, the non-aqueous liquid phase, dispersed in the continuous aqueous phase, being comprised of prepolymer liquid wherein the state of the prepolymer liquid irreversibly changes from a liquid to a solid in response to irradiation of electron beams; (b) drying ink on the inked textile with heat; and (c) curing the ink on the inked textile by irradiating with electron beams.

The irradiation of electron beams may be at a dosage between 1 kGy and 150 kGy. The irradiation of electron beams may be at a dosage between 10 kGy and 50 kGy. The process for printing the aqueous ink may be an inkjet printer.

A process for printing a textile comprises (a) printing a textile with an aqueous ink to create an inked textile, the aqueous ink including a non-aqueous dispersed liquid phase, a continuous aqueous phase, a thermal initiator, and a colorant, the continuous aqueous phase being comprised of water, a water miscible organic solvent, and a surfactant, the non-aqueous liquid phase, dispersed in the continuous aqueous phase, being comprised of prepolymer liquid wherein the state of the prepolymer liquid irreversibly changes from a liquid to a solid in response to application of heat; and (b) drying and curing the ink on the inked textile by applying heat.

The application of heat may be at a temperature greater than 60° C. and the application of heat may be applied for more than 1 second. The application of heat may be at a temperature greater than 100° C. and the application of heat may be applied for more than 10 seconds. The process for printing the aqueous ink may be an inkjet printer.

A system for printing a textile comprises an inkjet printer for printing a textile with an aqueous inkjet ink; the aqueous inkjet ink including a non-aqueous dispersed liquid phase, a continuous aqueous phase, and a colorant; the continuous aqueous phase being comprised of water, a water miscible organic solvent, and a surfactant; the non-aqueous liquid phase, dispersed in the continuous aqueous phase, being comprised of prepolymer liquid wherein the state of the prepolymer liquid irreversibly changes from a liquid to a solid in response to irradiation of electron beams; and a drying/curing device for drying and curing the ink on the textile by first applying heat to dry the ink and by subsequently irradiating the printed textile with electron beams to cure the ink.

The irradiation of electron beams may be at a dosage between 1 kGy and 150 kGy. The irradiation of electron beams may be at a dosage between 10 kGy and 40 kGy.

A system for printing a textile comprises an inkjet printer for printing a textile with an aqueous inkjet ink; the aqueous inkjet ink including a non-aqueous dispersed liquid phase, a continuous aqueous phase, a thermal initiator, and a colorant; the continuous aqueous phase being comprised of water, a water miscible organic solvent, and a surfactant; the non-aqueous liquid phase, dispersed in the continuous aqueous phase, being comprised of prepolymer liquid wherein the state of the prepolymer liquid irreversibly changes from a liquid to a solid in response to application of heat; and a drying/curing device for drying and curing the ink on the textile by applying heat.

The application of heat may be at a temperature greater than 60° C. and the application of heat may be applied for more than 1 second. The application of heat may be at a temperature greater than 100° C. and the application of heat may be applied for more than 10 seconds.

A system for printing a textile with ink from an inkjet printer, comprises an inkjet printer for printing a textile with an aqueous inkjet ink; the aqueous inkjet ink including a non-aqueous dispersed liquid phase, a continuous aqueous phase, and a colorant; the continuous aqueous phase being comprised of water, a water miscible organic solvent, and a surfactant; the non-aqueous liquid phase, dispersed in the continuous aqueous phase, being comprised of prepolymer liquid wherein the state of the prepolymer liquid irreversibly changes from a liquid to a solid in response to irradiation of electron beams; a drying device for drying the ink on the textile by applying heat; and a curing device for curing the ink on the textile by irradiating the textile with electron beams.

The irradiation of electron beams may be at a dosage between 1 kGy and 150 kGy. The irradiation of electron beams may be at a dosage between 10 kGy and 40 kGy.

A printed textile produced by an inkjet printing process, comprises (a) printing a textile with an aqueous inkjet ink to create an inked textile, the aqueous inkjet ink including a non-aqueous dispersed liquid phase, a continuous aqueous phase, and a colorant, the continuous aqueous phase being comprised of water, a water miscible organic solvent, and a surfactant, the non-aqueous liquid phase, dispersed in the continuous aqueous phase, being comprised of prepolymer liquid wherein the state of the prepolymer liquid irreversibly changes from a liquid to a solid in response to irradiation of electron beams; and (b) drying the ink on the inked textile by applying heat and curing the ink on the inked textile by irradiating with electron beams.

A printed textile produced by an inkjet printing process, comprises (a) printing a textile with an aqueous inkjet ink to create an inked textile, the aqueous inkjet ink including a non-aqueous dispersed liquid phase, a continuous aqueous phase, a thermal initiator, and a colorant, the continuous aqueous phase being comprised of water, a water miscible organic solvent, and a surfactant, the non-aqueous liquid phase, dispersed in the continuous aqueous phase, being comprised of prepolymer liquid wherein the state of the prepolymer liquid irreversibly changes from a liquid to a solid in response to application of heat; and (b) drying and curing the ink on the inked textile by applying heat.

It will be appreciated that variations of the above-disclosed embodiments and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the description above and the following claims.

What is claimed is:

1. An aqueous inkjet ink for direct printing onto textiles comprising:
a non-aqueous dispersed liquid phase;
a continuous aqueous phase;
a thermal initiator; and
a colorant;
said continuous aqueous phase being comprised of water, a water miscible organic solvent, and a surfactant;
said non-aqueous liquid phase, dispersed in said continuous aqueous phase, being comprised of prepolymer liquid wherein the state of said prepolymer liquid irreversibly changes from a liquid to a solid in response to application of heat.

2. The aqueous inkjet ink, as claimed in claim 1, wherein said thermal initiator is hydrophobic.

3. The aqueous inkjet ink claimed in claim 1, wherein said non-aqueous liquid phased contains said thermal initiator.

4. The aqueous inkjet ink, as claimed in claim 1, wherein said non-aqueous thermal initiator is initially dissolved in a hydrophobic solvent and emulsified into the aqueous inkjet ink.

5. The aqueous inkjet ink, as claimed in claim 1, wherein said thermal initiator is dispersed in the aqueous inkjet ink.

6. The aqueous inkjet ink, as claimed in claim 1, wherein said aqueous continuous phase contains said thermal initiator.

7. The aqueous inkjet ink, as claimed in claim 1, wherein said thermal initiator is soluble in said aqueous continuous phase.

8. The aqueous inkjet ink, as claimed in claim 1, wherein said continuous aqueous phase has a viscosity in the range of 1 to 100 cP at 25° C.

9. The aqueous inkjet ink, as claimed in claim 1, wherein said prepolymer liquid has a viscosity in the range 1 cP to 1×10⁷ cP at 25° C.

10. The aqueous inkjet ink, as claimed in claim 1, wherein the application of heat causes said prepolymer liquid to convert to a high viscosity solid polymer.

11. The aqueous inkjet ink, as claimed in claim 1, wherein the application of heat is at a temperature greater than 60° C.

12. The aqueous inkjet ink, as claimed in claim 1, wherein a half-life of said thermal initiator is less than or equal to a minimum available time for polymerization of said prepolymer liquid.

13. The aqueous inkjet ink, as claimed in claim 1, wherein 3 to 10 half-lives of the thermal initiator fit within a minimum available time for polymerization of said prepolymer liquid.

14. The aqueous inkjet ink, as claimed in claim 1, wherein the application of heat is at a temperature greater than 100° C. and the application of heat is applied for more than 10 seconds.

15. An aqueous inkjet ink for direct printing onto textiles comprising:
a non-aqueous dispersed liquid phase;
a continuous aqueous phase; and
a colorant;
said continuous aqueous phase being comprised of water, a water miscible organic solvent, and a surfactant;
said non-aqueous liquid phase, dispersed in said continuous aqueous phase, being comprised of prepolymer liquid wherein the state of said prepolymer liquid irreversibly changes from a liquid to a solid in response to irradiation of electron beams.

16. The aqueous inkjet ink, as claimed in claim 15, wherein said continuous aqueous phase has a viscosity in the range of 1 to 100 cP at 25° C.

17. The aqueous inkjet ink, as claimed in claim 15, wherein said prepolymer liquid has a viscosity in the range 1 cP to 1×10⁷ cP at 25° C.

18. The aqueous inkjet ink, as claimed in claim 15, wherein the irradiation of electron beams is at a dosage between 1 kGy and 150 kGy.

19. The aqueous inkjet ink, as claimed in claim 15, wherein the irradiation of electron beams is at a dosage is between 10 kGy and 50 kGy.
